(19) United States
(12) Patent Application Publication
(10) Pub. No.: US 2026/0037270 A1
(43) Pub. Date: Feb. 5, 2026

(54) HOST INSTRUCTIONS

(71) Applicant: Arm Limited, Cambridge, Cambridgeshire (GB)

(72) Inventors: Ian Rudolf BRATT, Portola Valley, CA (US); Richard Roy GRISENTHWAITE, Cambridge (GB); Carlos GARCIA-TOBIN, Ely (GB); James Edward KING, Wokingham (GB); Mark David HAMBLETON, Surbiton (GB); Sven Ola Johannes HUGOSSON, Lund (SE)

(21) Appl. No.: 18/793,092

(22) Filed: Aug. 2, 2024

(51) Int. Cl. G06F 9/38; G06F 9/48

(52) U.S. Cl. CPC G06F 9/3885; G06F 9/4843

(57) ABSTRACT

A data processing method comprises: executing at least one operation on a first-level CPU, the at least one operation configured to cause a machine learning process to initiate; and issuing a request to a second-level CPU configured to coordinate a plurality of third-level CPUs to perform at least part of the machine learning process, wherein the first-level CPU and the second-level CPU run separate operating systems.

### TECHNICAL FIELD

The present disclosure relates to data processing.

### DESCRIPTION

Data processing systems typically have a central processing unit (CPU) which is the primary compute component which interprets, processes and executes instructions of software programs being executed, and controls other parts of the processing system to perform tasks on behalf of programs executed on the CPU. Unlike more specialised processing elements such as graphics processing units (GPUs) or neural processing units (NPUs), which are optimised to handle a specific class of operations, CPUs typically support a general purpose instruction set and handle execution of general purpose software and operating systems which could not run on a more specialised processing element.

### SUMMARY

Viewed from a first example configuration, there is provided a data processing method comprising:
executing at least one operation on a first-level CPU, the at least one operation configured to cause a machine learning process to initiate; and
issuing a request to a second-level CPU configured to coordinate a plurality of third-level CPUs to perform at least part of the machine learning process, wherein
the first-level CPU and the second-level CPU run separate operating systems.

Viewed from a second example configuration, there is provided a data processing method comprising:
obtaining at a second-level CPU, via an interface to a first-level CPU, a request to perform a machine learning process; and
coordinating a plurality of third-level CPUs to participate in performing the machine learning process, wherein
the first-level CPU and the second-level CPU run separate operating systems.

Viewed from a third example configuration, there is provided an apparatus configured to perform the method of any of the first and second example configurations.

Viewed from a fourth example configuration, there is provided a non-transitory computer-readable medium storing computer-readable code for fabrication of an apparatus configured to perform the method of any of the first and second example configurations.

Viewed from a fifth example configuration, there is provided a system comprising: the apparatus of the third example configuration, implemented in at least one packaged chip;
at least one system component; and
a board, wherein
the at least one packaged chip and the at least one system component are assembled on the board.

Viewed from a sixth example configuration, there is provided a chip-containing product comprising the system of the fifth example configuration, wherein the system is assembled on a further board with at least one other product component.

### BRIEF DESCRIPTION OF THE DRAWINGS

The present invention will be described further, by way of example only, with reference to embodiments thereof as illustrated in the accompanying drawings, in which:

FIG. 1 illustrates an example of a data processing system comprising a compute cluster;

FIG. 2 illustrates an example of a compute tile comprising a tile CPU and a hardware accelerator;

FIG. 3 illustrates an example of accelerator control registers provided by an accelerator control interface via which the tile CPU can control the hardware accelerator to perform delegated tasks;

FIG. 4 illustrates an example of signalling on the accelerator control interface;

FIG. 5 illustrates a more detailed example of a host compute system comprising an embedded compute cluster;

FIGS. 6 and 7 show examples of compute clusters scaled to differing performance requirements;

FIG. 8 shows an example where the compute cluster is a standalone device coupled to a host compute system via an interface such as a peripheral interface or inter-chiplet interface;

FIG. 9 shows an example of the standalone compute cluster of FIG. 8;

FIG. 10 illustrates a CPU offload hierarchy;

FIG. 11 illustrates a system and a chip-containing product;

FIG. 12 illustrates cooperation between a host CPU, cluster CPU and tile CPUs when performing a machine learning process;

FIG. 13 illustrates capability determination;

FIG. 14 illustrates an example of a process executed by the host CPU;

FIG. 15 illustrates an example of decomposing a machine learning process into sub-processes;

FIG. 16 illustrates an example of a software stack;

FIGS. 17A and 17B illustrate two different examples in which a machine learning request can be issued by the host CPU;

FIG. 18 illustrates model security; and

FIGS. 19A, 19B and 20 illustrate example methods.

### DESCRIPTION OF EXAMPLE EMBODIMENTS

Before discussing the embodiments with reference to the accompanying figures, the following description of embodiments is provided.

An apparatus comprises a plurality of compute tiles coupled via a tile cluster interconnect. Each compute tile comprises: a tile central processing unit (CPU); and a hardware accelerator configured to perform, asynchronously with respect to operations performed by processing circuitry of the tile CPU, a delegated task offloaded to the hardware accelerator by the tile CPU. Hence, the apparatus comprises a cluster of hardware accelerators having respective tile CPUs. By providing a cluster of hardware accelerators, this can help to parallelize computationally-expensive operations of a type which can be relatively inefficient to perform using a CPU supporting a general purpose instruction set. For example, multiple sub-tasks of a more complex process can be run in parallel on respective hardware accelerators of the cluster. By providing each hardware accelerator with a corresponding tile CPU, responsibility for issuing of low-level accelerator commands to each accelerator can be distributed among the tile CPUs, reducing the overhead experienced by a CPU at a central control point, compared to a centralized control model where a central control point is responsible for all accelerator control. Hence, the cluster of compute tiles can help improve performance for operations to be accelerated.

In some examples, each compute tile may have the same functional design. Some examples may provide each compute tile with the same physical layout, e.g. with tiles laid out in a regular array (e.g. grid) pattern, each element of the array comprising a tile CPU and hardware accelerator. Other examples may not necessarily use the same physical layout for each compute tile, but may provide logically identical compute tiles (tiles having the same functional components, even if laid out differently on a chip). It is also possible to include multiple types of compute tile, so that not all compute tiles are necessarily the same. For example, respective types of compute tiles could support different types of hardware accelerator which support different subsets of processing operations, or it may be possible to provide compute tiles with different performance characteristics (e.g. a more energy-efficient, but lower performance, compute tile, in combination with a higher performance, but more power-hungry, compute tile, to allow trade-offs of computational power against energy costs). Hence, there are a variety of options for implementing the compute tiles. Nevertheless, in general using a tiled arrangement where a system is built up from a number of compute tiles, each compute tile including (at least) a tile CPU and a hardware accelerator, can be helpful to provide a system which is scalable to different performance requirements by varying the number of compute tiles provided. Hence, in some examples the compute tiles may support a modular design and particular implementations may vary the number of compute tiles provided.

A hardware accelerator provides hardware circuitry supporting a certain class of specialized operations, which can be performed more efficiently by the hardware accelerator in hardware than could be performed in software using instructions of a general purpose instruction set supported by a CPU. The accelerator may be designed for a particular purpose, rather than for general purpose processing. The accelerator could comprise fixed-function circuit logic, or alternatively could have some degree of programmability, although with less flexibility in terms of the operations supported than would be supported by a general purpose CPU. For example, the accelerator may support a limited set of complex functions each corresponding to a certain combination of low-level functions such as arithmetic/logical operations rather than supporting directives controlling each instance of a basic arithmetic/logical operation using a separate instruction. The accelerator may be incapable of execution of an operating system.

Each compute tile has at least one hardware accelerator. In some examples, a compute tile could include more than one hardware accelerator (e.g. two or more accelerators supporting different classes of operations). Hence, some tiles may have one tile CPU associated with multiple hardware accelerators. However, some implementations may support a one-to-one mapping between tile CPUs and hardware accelerators.

The hardware accelerator on each compute tile could implement a variety of classes of processing operations as the specialized operations implemented using the accelerator. For example, the accelerator could implement algorithms for digital signal processing, cryptographic functions, data compression, physics simulation, etc.

However, the use of a cluster of compute tiles as discussed above can be particularly useful where the hardware accelerator comprises accelerator circuitry configured to accelerate operations for one or more machine learning workloads. For example, the hardware accelerator may comprise a machine learning accelerator, also known as an artificial intelligence (AI) accelerator, neural processing unit (NPU), or neural engine. The computational demands of machine learning applications are rapidly growing, so high-performance support for machine learning workloads is increasingly important. Many machine learning problems, such as processing of a prompt supplied to a large language model (LLM), may involve the problem to be decomposed into multiple sub-problems (e.g. a complex prompt can be decomposed into a number of simpler prompts). Each sub-problem may be capable of acceleration using a machine learning accelerator, so it can be beneficial to performance to be able to parallelize machine learning tasks using a cluster of compute tiles each comprising respective hardware accelerators.

In some examples, for a given compute tile, the hardware accelerator is private to the tile CPU of that given compute tile. Hence, while other CPUs may be able to indirectly request that the hardware accelerator on a particular compute tile carries out functionality, by issuing directives to the tile CPU of that compute tile, the tile CPU on a given compute tile may have sole responsibility for issuing commands to the hardware accelerator of that compute tile to control the hardware accelerator to carry out delegated processing actions, and other CPUs are not able to directly control the hardware accelerator on that given compute tile. As the hardware accelerator is private to its associated tile CPU, the accelerator can be integrated much more tightly into the design of the tile CPU, so that latency of offloading operations to the hardware accelerator from the tile CPU can be reduced.

The tile CPU may exchange control signals with the hardware accelerator via an accelerator control interface separate from the tile cluster interconnect (and also separate from the system interface to a host system which mentioned further below). By providing a dedicated interface between the tile CPU and hardware accelerator on a given compute tile, accelerator control commands do not need to compete for bandwidth with memory access requests on the tile cluster interconnect, and so performance can be improved for accelerator control.

In some examples, for a given compute tile, the hardware accelerator is configurable based on instructions executed by the tile CPU in an operating state with user-level privilege. For example, the user-level privilege may be the least privileged level of privilege supported by the processing circuitry (e.g. a state less privileged than an operating system level of privilege). Direct configuration of the accelerator from user-level software can be beneficial in reducing performance overhead associated with configuration of the accelerator, since it removes the need for user-level application software to call more privileged software (e.g. an operating system or hypervisor) to request access to the accelerator, which would cause a significant delay associated with exception entry/exit processes.

In some examples, for a given compute tile, the tile CPU and the hardware accelerator are configured to share memory management circuitry. For example, the shared memory management circuitry may perform address translation functions (e.g. the translation mappings themselves, and/or page table walk operations) on behalf of both memory access requests initiated by the tile CPU and accelerator-triggered memory access requests initiated by the hardware accelerator. The accelerator can issue access requests specifying virtual addresses, and reuse the memory management circuitry of the tile CPU for address translation. As the accelerator-triggered memory access requests specify virtual addresses, and the memory management circuitry of the tile CPU is reused to translate the virtual addresses specified by a hardware accelerator, this greatly reduces the software complexity in configuring the hardware accelerator, as the hardware accelerator can simply see the same virtual address space as the process running on the tile CPU that configured the hardware accelerator to perform the delegated task. Unlike systems where physical addresses are used for accelerator-triggered accesses, there is no need for use of memory pinning (software locking of page table entries that map the physical memory used by a hardware accelerator, to prevent those regions of physical memory being reallocated for other purposes until the accelerator has completed its task using that physical memory). Such memory pinning would typically incur a performance cost because a more privileged piece of software may need to be called to manage the memory pinning, interrupting the process that is requesting use of the hardware accelerator. Hence, reusing the tile CPU's memory management circuitry (which is also used for translations performed in response to memory access instructions executed by processing circuitry of the tile CPU) for translation of accelerator-triggered memory access requests is helpful for reducing the software overheads associated with configuring the accelerator. This can make it more feasible for the accelerator to be used for relatively short delegated tasks for which the configuration overhead would otherwise be prohibitive, thus giving more opportunities to free the tile CPU for other purposes, and hence helping to improve processing performance in the system as a whole.

In some examples, for a given compute tile, the tile CPU and the hardware accelerator are configured to share at least one private cache. The private cache may be accessible to the tile CPU and hardware accelerator but inaccessible to any other CPU. In some examples, the private cache may be a level-two cache (the tile CPU also having a level-one cache which may not necessarily be accessible to the at least one hardware accelerator). By providing the accelerator with access to the tile CPU's private cache, rather than only being able to share data between tile CPU and accelerator via memory, this can support better performance. Following completion of a given accelerator task the tile CPU may need to perform an operation dependent on a result obtained by the accelerator, and that result can be obtained faster if the accelerator can write it into the tile CPU's private cache, compared to if the tile CPU and accelerator shared data only via memory.

In some examples, each compute tile comprises an associated system cache. Providing a system cache per compute tile can provide a large amount of cache storage at system level (e.g. associated with the tile cluster interconnect), which can help improve performance for data-intensive workloads such as machine learning operations. The apparatus may also comprise system interface circuitry configured to provide an interface between: a compute cluster comprising the plurality of compute tiles and the tile cluster interconnect; and a host compute system comprising at least one CPU and system memory. Hence, the compute cluster may be a self-contained, scalable, accelerator system which can be deployed into a host compute system to provide accelerated processing functionality within the host compute system.

In some examples, the system interface circuitry comprises a peripheral interconnect. For example, the system interface circuitry may be a PCIe (Peripheral Component Interconnect Express) interface.

In some examples, the system interface circuitry comprises an inter-chiplet interconnect. Hence, in some examples the compute cluster comprising the compute tiles and tile cluster interconnect may be implemented on a chiplet, which may be integrated with other chiplets of the host compute system by communicating via an inter-chiplet interconnect (e.g. an interposer). The inter-chiplet interconnect could, for example, operate according to the UCIe (Universal Chiplet Interconnect Express) protocol.

In some examples, the system interface circuitry comprises a memory system interconnect. For example, the memory system interconnect may operate a coherency protocol to maintain coherency between data cached in respective requesters coupled to the memory system interconnect. Those requesters may include a system host CPU of the host compute system as well as including the compute cluster. Alternatively, the memory system interconnect could be a non-coherent interconnect, so that there is no hardware-maintained coherency protocol within the memory system interconnect by which the compute cluster is coupled to the host system.

In some examples, the compute cluster has access to the memory of the host compute system, as well as having one or more caches within the compute cluster which cache data from the memory of the host compute system.

However, in some examples, the compute cluster may also comprise cluster memory storage circuitry private to the compute cluster and inaccessible to the host compute system. Providing dedicated memory (e.g. random access memory, e.g. DDR SDRAM) can be helpful to improve performance for the compute cluster by improving memory bandwidth compared to an approach where all memory accesses initiated by the compute cluster have to compete with the host compute system for bandwidth in accessing the host system memory. For example, the cluster memory storage circuitry may comprise high bandwidth memory (HBM).

In some examples, the apparatus (compute cluster) also comprises a cluster host CPU coupled to the plurality of compute tiles via the tile cluster interconnect. Unlike the tile CPUs, the cluster host CPU does not itself need to have a corresponding hardware accelerator (although the cluster host CPU might still be able to access some accelerator functionality via other mechanisms, e.g. by accessing a remote accelerator coupled to the primary system interconnect mentioned below). Providing an additional cluster host CPU (not coupled to any specific accelerator), as well as the tile CPUs responsible for accelerator control, can be helpful for managing allocation of compute tasks to the respective compute tiles and/or interfacing with other requesters external to the compute tiles.

For example, the cluster host CPU may be responsible for delegating compute tasks to the respective compute tiles. The cluster host CPU may communicate with the host compute system to accept offloading of a compute task from the host compute system to a compute cluster comprising the cluster host CPU and the plurality of compute tiles. The cluster host CPU may receive job requests from a host compute system and dispatch jobs to the compute tiles. Hence, by providing a cluster host CPU which acts as an interface between the tiles of the compute cluster and the host compute system, and which can manage the allocation of compute jobs to each tile, this can alleviate the need for a system host CPU within the host compute system to manage specific allocations of compute tasks for each compute tile, which can greatly reduce the performance cost of a system host CPU which might wish to offload relatively complex job requests to the compute cluster. By providing the cluster host CPU, the system host CPU can offload jobs at a higher-level of a software stack. This can help maintain processing performance at the system host CPU, giving better user experience to the user of the overall host system. For example, if the host CPU can offload a machine learning or other accelerated task at a much higher level of a software stack, rather than needing to perform lots of memory accesses to control accelerators at a specific level, then the user perceives less disruption to the running of other user-visible applications such as an internet browser or video player.

The cluster host CPU may also decompose a compute task offloaded by the host compute system into portions to be performed by the plurality of compute tiles. For example, the cluster host CPU can receive a request for a more complex task and break the task down into a number of smaller tasks to be performed by respective compute tiles of the compute cluster. For example, a more complex prompt to a large language model could be split into simpler prompts to be processed independently, or regions of interest could be detected within an image with each region of interest being allocated for further processing on respective compute tiles.

The cluster host CPU may also combine results generated by respective compute tiles to assemble a result to be returned as a response to the job request received from the host compute system.

The compute cluster could also include other components, other than the compute tiles and the cluster host CPU. For example, the compute cluster could include other support resources. For example, the apparatus could include any one or more of the following support components, coupled to the tile cluster interconnect:
a system control processor configured to perform system initialization;
a security engine configured to provide confidential compute functionality;
debugging circuitry;
an interrupt controller; and
a peripheral interface.
   The tile cluster interconnect could take various topologies or have various designs. However, in one particular example, the tile cluster interconnect comprises a coherent mesh network. A mesh network can be a suitable topology for connecting a tiled layout and may be easily scalable to different numbers of compute tiles.

Each tile CPU may be capable of execution of at least one of: an operating system; and a machine learning framework. Hence, the tile CPU may be a fully-featured CPU capable of operating system execution (not merely a limited-function processor). Portions of a machine learning framework (e.g. Pytorch or TensorFlow) may be offloaded to the tile CPU.

The tile CPUs may support an N-bit architecture, where N>32. Similarly, the cluster host CPU may support an N-bit architecture, where N>32. For a CPU with an N-bit architecture, memory address operands may logically comprise N bits and integer general purpose registers may store N-bit values. For example, the tile CPUs and/or cluster host CPU may implement the A-profile instruction set architecture (ISA) provided by Arm® Limited of Cambridge, UK. Instruction set architectures designed for memory address operands and register operands with greater than 32 bits (e.g. 64-bit architectures) tend to be associated with higher-performance processors, compared to 32-bit architectures which now tend to be used for simpler processors such as microcontrollers.

In some examples, a compute system comprises a CPU (central processing unit) hierarchy comprising: a first-level CPU; a second-level CPU; and a plurality of third-level CPUs. This arrangement can provide better performance for relatively complex tasks involving multiple sub-tasks which need to operate in parallel with other user-visible applications such as internet browsing. By providing three-levels of CPUs, with multiple CPUs at the third level, the parallelized sub-tasks can be allocated to the third-level CPUs under control of the second-level CPU while the user-visible applications can remain on the first-level CPU. This can provide better processing performance.

In some examples, each third-level CPU has a corresponding hardware accelerator. The three-level CPU hierarchy can be particularly effective for tasks which may benefit from hardware acceleration. The low-level commands needed for accelerator control can be handled by the third-level CPUs, freeing the first-level and second-level CPUs from the need to execute specific accelerator drivers.

Each third-level CPU may comprise an accelerator interface configured to communicate with the corresponding hardware accelerator to control offloading of a delegated task to the corresponding hardware accelerator. The corresponding hardware accelerator may perform the delegated task asynchronously with respect to operations performed on a processing pipeline of the third-level CPU. For a given third-level CPU the accelerator interface may be separate from an interface by which the third-level CPU accesses a memory system.

The corresponding hardware accelerator for a given third-level CPU may be private to the given third-level CPU. As mentioned above for the compute tile example, use of a private accelerator enables the accelerator to be coupled more tightly to the corresponding CPU, which helps improve performance. Any of the features discussed above for the hardware accelerator of the compute tiles may be provided for the accelerator associated with a given third-level CPU (which may correspond to the tile CPU described earlier).

In some examples, the corresponding hardware accelerator comprises accelerator circuitry configured to accelerate operations for one or more machine learning workloads. The hierarchy comprising at least the first-level CPU, second-level CPU and third-level CPUs can be particularly beneficial for handling machine learning workloads, because machine learning tasks often require a number of layers of decomposition into simpler tasks, and so the second-level CPU can be helpful to allow the first-level CPU to offload the task at a higher level of the software stack with the second-level CPU taking the burden of managing specific sub-tasks to be performed by each third-level CPU.

It will be appreciated that, in some examples, the first-level CPU, second-level CPU and third-level CPUs correspond to the system host CPU, cluster host CPU and tile CPUs mentioned above for the compute cluster example.

In general, the hierarchy comprises at least one first-level CPU, at least one second-level CPU and two or more third-level CPUs. However, some examples may provide a hierarchy which support multiple first-level CPUs or multiple second-level CPUs.

In some examples, the first-level CPU is configured to offload compute tasks to the second-level CPU and the second-level CPU is configured to offload compute tasks to the third-level CPUs. Hence, the hierarchy may be a delegation hierarchy, with the first-level CPU being at the highest level of the hierarchy and the second and third-level CPUs being at successive lower (subsidiary) levels. The second-level CPU can act as an intermediary in the hierarchy, between the first-level CPU and third-level CPUs. While at first glance this may seem inefficient compared to the first-level CPUs interacting with the third-level CPUs directly, in practice the second-level CPU can greatly reduce the overhead incurred at the first-level CPU for controlling the third-level CPUs, which can be particularly beneficial for tasks such as machine learning functions (e.g. processing of prompts using a large language model) which may involve a number of layers of decomposing a more complex task into simpler sub-tasks. If the first-level CPU had to control the third-level CPUs directly, this could incur significant overhead at the first-level CPU, which may harm performance for user-visible applications (e.g. internet browsers) also running at the first-level CPU. In contrast, by offloading the tasks at a higher level to the second-level CPU which can manage allocation of such tasks to the third-level CPUs, system performance can be maintained at the first-level CPU. In some examples, the second-level CPU is configured to receive job requests from the first-level CPU and to dispatch jobs to the third-level CPUs.

In some examples, the second-level CPU is configured to decompose an offloaded compute task offloaded by the first-level CPU into sub-tasks to be performed by the third-level CPUs. The workloads sent from the second-level CPU to the third-level CPUs may be derived from the workload sent from the first-level CPU to the second-level CPU, but may not necessarily be explicitly present in the high level commands sent by the first-level CPU to the second-level CPU. By using the second-level CPU to decompose a more complex task into sub-tasks, this greatly reduces burden on the first-level CPU which is freed to process other applications with greater performance.

In some examples, the first-level CPU and the second-level CPU may be configured to communicate via a primary interconnect, and the second-level CPU and the third-level CPUs are configured to communicate via a secondary interconnect separate from the primary interconnect.

For example, the primary interconnect may comprise a plurality of primary interconnect endpoint interfaces, and the secondary interconnect may be coupled to at least one of the primary interconnect endpoint interfaces. The first-level CPU may be coupled to at least one other of the primary interconnect endpoint interfaces. Hence, the second-level CPU and third-level CPUs may in some cases be subsidiary to the first-level CPU in the sense that they may not necessarily be directly coupled to the primary system interconnect used by the first-level CPU.
The secondary interconnect may comprise a plurality of secondary interconnect endpoint interfaces, with at least one of the secondary interconnect endpoint interfaces being coupled to the primary interconnect, and the second-level CPU and the third-level CPUs coupled to respective secondary interconnect endpoint interfaces of the secondary interconnect.

The secondary interconnect may correspond to the tile cluster interconnect mentioned earlier.

The secondary interconnect may comprise a coherent interconnect, so that the second-level and third-level CPUs may be cache-coherent (with hardware circuitry of the coherent interconnect managing coherency of data cached in private caches of the second-level CPU and third-level CPUs according to a given coherency protocol). The secondary interconnect may comprise a mesh network, for example.
In some examples, the primary interconnect may be a coherent interconnect, such that the first-level CPU may be coherent with respect to the second-level CPU and third-level CPUs.

However, in other examples, the primary interconnect may be a non-coherent interconnect, such that there is no hardware-managed coherency protocol which maintains cache coherency between the first-level CPU and a compute cluster comprising the second-level CPU and third-level CPUs. In this case, in absence of any coherency enforcing measures implemented by software (such as explicit cache invalidation commands to invalidate cached data held by another CPU when shared data is updated from a given CPU), the first-level CPU may be non-coherent with respect to the compute cluster comprising the second-level CPU and third-level CPUs. Nevertheless, a hardware-managed coherency protocol may be implemented on the secondary interconnect to maintain coherency between the second-level CPU and third-level CPUs.

The primary interconnect may comprise a memory system interconnect, peripheral interconnect or inter-chiplet interconnect, for example.

The compute system may comprise system memory storage circuitry coupled to the primary interconnect and shared for access by the first-level CPU, the second-level CPU and the third-level CPUs.

The first-level CPU may access the system memory storage circuitry via the primary interconnect, while the second-level CPU and the third-level CPUs may access the system memory storage circuitry via a path comprising the secondary interconnect and the primary interconnect.

The compute system may also comprise cluster memory storage circuitry accessible to a cluster comprising the second-level CPU and the third-level CPUs. The cluster memory storage circuitry may be inaccessible to the first-level CPU. For example, the cluster memory storage circuitry may comprise DDR SDRAM or HBW.

At least the first-level CPU and the second-level CPU (and in some examples, also the third-level CPUs) may be capable of execution of at least one of: an operating system; and a machine learning framework.

In some examples, the second-level CPU is configured to support an N-bit architecture, where N is greater than 32. In some examples, the third-level CPUs are configured to support an N-bit architecture, where N is greater than 32. The third-level CPUs may also support an N-bit architecture, where N is greater than 32. It is not necessary for the number of bits for N to be the same for each of the levels of CPU.

In accordance with some examples, there is provided a data processing method comprising: executing at least one operation on a first-level CPU, the at least one operation configured to cause a machine learning process to initiate; and issuing a request to a second-level CPU configured to coordinate a plurality of third-level CPUs to perform at least part of the machine learning process, wherein the first-level CPU and the second-level CPU run separate operating systems.

The first-level CPU could for instance be a host CPU that executes within a system. In these examples, it executes a stream of instructions containing some machine learning instruction(s) that caused a machine learning process to take place. To cause the machine learning process to be performed, a request is issued to a second-level CPU (different from the first-level CPU), which is used to coordinate a plurality of third-level CPUs (different from the first-level CPU and the second-level CPU). The second-level CPU may take the form of a cluster CPU and the third-level CPUs may take the form of combined CPU/accelerator pairs. The request causes the third-level CPUs to participate in the machine learning process (i.e. using the model and the input data). Within this example, the first-level CPU and the second-level CPU are each configured to run separate operating systems. The operating systems that execute on each of the first-level CPU and the second-level CPU are not necessarily different but are separate. That is to say that they each execute different operating system instances (which may also be different types of operating system). For instance, one may run Windows with the other running Linux, or both may run separate copies of Linux. By providing the separate operating systems, the first-level CPU may have a different view of the resources available in the system to that of the second-level CPU. That is to say that for instance the first-level CPU may be unable to see or directly interact with the third-level CPUs for instance. This makes it possible for the first-level CPU to have an increased level of decoupling from the machine learning process. For instance, the machine learning process can be initiated by the first-level CPU, which is thereafter permitted to perform its own execution on other tasks and processes without necessitating ongoing coordination with the processors performing the machine learning. This leads to increased efficiency of resources within the system.

In some examples, the method comprises: determining whether the second-level CPU is available to the first-level CPU; and in response to a result of the determining being that the second-level CPU is available to the first-level CPU, performing the issuing. In these examples, a determination process is performed prior to issuing the request to the second-level CPU. The determination is whether the second-level CPU is available to the first-level CPU. This may be performed implicitly, e.g. by detecting the cluster that contains the second-level CPU rather than detecting the second-level CPU directly. Consequently, rather than performing the issuing ‘blindly’ and assuming that the second-level CPU is present, a determination is made beforehand.

In some examples, in response to the result of the determining being that the second-level CPU is unavailable to the first-level CPU causing an unavailability response to occur. Where a determination is made to check whether the second-level CPU is available/inaccessible or not, one or more actions can be taken where it is determined that there is no availability/accessibility:

An error could be raised at the first-level CPU—this error may take the form of an exception or interrupt, which can be caught by software and responded to.

The first-level CPU can be made to do the process itself.

The user could be alerted, potentially being queried as to which other action should be taken.

The execution of the stream of instructions can be halted.

The determination can be performed again after waiting for a predetermined period. This particular action could be limited to only being performed N times.

As a consequence of this, it is not necessary for the first-level CPU to know ahead of time as to whether the second-level CPU is available or not.

In some examples, the machine learning process is defined at the first-level CPU at a same or higher level of abstraction than is used at the second-level CPU. Different levels of abstraction can be achieved by providing functionality at one level that itself uses functionality provided by a lower level. At a lowest level, individual commands are sent to the hardware via, e.g. a driver or other hardware controlling resource.

In some examples, the issuing the request to the second-level CPU occurs via an API.

In some examples, the request is issued to the second-level CPU via a host machine learning framework executing on an operating system of the first-level CPU. The framework can take a number of different forms, as will be explained below.

In some examples, the host machine learning framework utilises an API by which the request is issued by the first-level CPU; and the request comprises an indication as to the process and the data to use when executing the process. An Application Programming Interface (API) is a set of instructions that are available for other programs to invoke in order to allow some particular behaviour to occur (as provided by the software that implements the API). In these examples, the API could be accessed by writing data to specified locations in memory, which are checked by the second-level CPU (or other hardware that provides the request to the second-level CPU), directly transmitting the request to the second-level CPU via an interconnect, bus, or other circuit structure, another technique that will be known to the skilled person, or some combination thereof.

In some examples, the host machine learning framework is configured to communicate with a cluster machine learning framework executing on an operating system of the second-level CPU. Multiple frameworks may therefore be provided—or a framework may be split between the host and the cluster.

In some examples, the request is issued to the second-level CPU and is handled by a cluster machine learning framework executing on a cluster operating system of the second-level CPU. In some examples, the framework is ‘compiled away’ at compilation time. However, in these examples, the framework runs as a service under the operating system of the second-level CPU making it possible for requests to be received dynamically.

In some examples, the issuing the request to the second-level CPU occurs via an API operating on a host operating system on the first-level CPU.

In some examples, the request comprises an indication of the machine learning process to be performed and an indication as to the data on which to operate the machine learning process. The request may comprise an indication of the model to be used. The model may comprise a machine learning architecture such as a neural network architecture and may include one or more weights (although these may be initially excluded as part of a training process). The input data may comprise training data that used to perform training or could comprise application data that is applied to the model in order to produce a result.

In some examples, the API specifies parameters of the machine learning process to be performed. One way in which the API can enable the machine learning process to take place is by providing particular parameters necessary to perform the machine learning process to the second-level CPU.

In some examples, the API is configured to enable the machine learning process to be issued to the second-level CPU; and the machine learning process is decomposed, at the second-level CPU, into sub processes for execution across the second-level CPUs and the third-level CPU. For instance, some of the sub-processes may execute on the second-level CPUs, and some may execute on the third-level CPUs. Those sub-processes that are executed on the second-level CPUs may include pre-processing sub-processes and/or post-processing sub-processes for instance.

In some examples, the machine learning process is decomposed for a first time, at the second-level CPU, into sub-processes for execution across the second-level CPU and the third-level CPUs. That is, prior to the machine learning process (via the request) being received at the second-level CPU, no decomposition has taken place.

In some examples, the API is configured to allow the machine learning process to be specified in a hardware agnostic manner. That is, the same request can be issued to a different second-level CPU with different third-level CPUs and can still be performed (presuming that the third-level CPUs are capable of performing the overall process if suitably instructed).

In some examples, the cluster machine learning framework is configured to obtain the request comprising an indication of one or more second-level instructions configured to be executed on the second-level CPU. Another technique that can be used for providing the request is to provide second-level instructions that are executed by the second-level CPU. As with other transmissions described here, this could be achieved by providing the actual instructions or could be achieved by providing a pointer to where the instructions are executed. By providing the request in this way, it is possible for arbitrary code to be executed on each of the second-level and third-level CPUs without resorting to particular pre-programmed techniques.

In some examples, the one or more second-level instructions cause execution of one or more asynchronous tasks. The second-level CPU may therefore cause the asynchronous tasks to be executed on each of the third-level CPUs.

In some examples, at least some of the second-level instructions and the asynchronous tasks comprise an indication of the input data and the model. The second-level instructions and/or asynchronous tasks could provide an indication of where the input data and/or model are located whereas in other examples the input data and/or model are directly provided.

In some examples, the machine learning process comprises a training process; and at least some of the second-level instructions and the asynchronous tasks comprise one or more training parameters. Training parameters can be used to not only confine the extent of the training, but also to define how the training should proceed.

In some examples, the one or more training parameters comprise an indication of an error function The error function can be provided as a location in code where particular code is to be executed and can be used to gauge the quality of a developing model (e.g. the current weights and biases that are being used).

In some examples, the machine learning process comprises an inference process. During inference, a trained model is applied to new input data to produce an output. For example, a trained model that distinguishes cats from dogs could be provided with a new image to be categorised as to whether it is a cat or a dog.

In some examples, the model is encrypted using a key; and the key is held in a trusted execution environment accessible to at least one of the second-level CPU and the third-level CPUs and inaccessible to the first-level CPU. The model (e.g. architecture and/or weights and/or biases) may not be accessible to the first-level CPU and may instead be encrypted. A trusted execution environment can be provided to the second-level CPU and/or the third-level CPUs that enable the model to be used. This makes it possible for the detail of the model to be obfuscated and kept private.

In some examples, the data processing method comprises: receiving an indication of a result of the machine learning process at the first-level CPU. Having performed the machine learning process (training and/or inference) at the second-level and third-level CPUs, a produced result can then be provided back to the first-level CPU. This can be provided directly or can be provided by providing a location in the memory where the result can be found.

In some examples, the machine learning process takes place over a plurality of epochs. In particular, in these cases, the machine learning process that occurs on the second-level CPU and the third-level CPU occurs over a number of epochs. This may either cover a number of iterations of training or a number of iterations of inference of the model or models. In some examples, this is carried out without further input from the first-level CPU such that the machine learning task can be offloaded from the first-level CPU, which can then perform other tasks. In other examples, input from the first-level CPU is kept low.

In some examples, the machine learning process that is performed by the second level CPU and at least one of the third level CPUs comprises a decision of whether to continue the machine learning process for another iteration. Consequently, the decision as to whether a further iteration is to be performed is taken without consulting the first-level CPU.

In accordance with some examples, there is provided a data processing method comprising: receiving at a second-level CPU, via an interface to a first-level CPU, a request to perform a machine learning process using a model and input data; and coordinating a plurality of third-level CPUs to participate in performing the machine learning process using the model and the input data, wherein the first-level CPU and the second-level CPU run separate operating systems.

The second-level CPU may, for instance, act as a cluster host and receive the request from the first-level CPU, which may act as a system host. Having received the request, the method then causes a plurality of third-level CPUs to participate in performing the machine learning process using the model and the input data that are indicated by the request. The first-level CPU and/or the second-level CPU run separate operating systems, which is not to say that the operating systems are different merely that they are separate and could therefore be different instances of the same operating system.

In accordance with some examples, there is provided a data processing method comprising: obtaining at a cluster CPU, a request to perform a machine learning process; and coordinating a plurality of tile CPUs to participate in performing the machine learning process, wherein the tile CPUs participate in performing the machine learning process by delegating asynchronous tasks to an accelerator attached to each respective tile CPU.

In the above examples, a request is obtained by a cluster CPU (also known as a second-level CPU) to perform a machine learning process. Having obtained (e.g. fetched or received) the request, a plurality of tile CPUs (also known as third-level CPUs) are coordinated to participate in the machine learning process. Each tile CPU is associated with a corresponding accelerator in order to form a ‘tile’. The tile CPUs are coordinated to participate in the machine learning process by a number of asynchronous tasks being issued (e.g. by the cluster CPU) to the accelerators. This allows for an efficient execution of the machine learning operation to be performed. For example, the coupling of tile CPUs with accelerators to form tiles allows more complicated acceleration to take place. Meanwhile, by issuing asynchronous tasks, it is possible for the tile CPUs to operate with relative independence (as compared to the tasks being synchronous). Furthermore, since the request is obtained by the cluster CPU, the machine learning process can occur with low support from devices outside the cluster that contains the cluster CPU and tiles.

In some examples, the asynchronous tasks executed by the accelerator attached to each respective tile CPU are to execute operations corresponding to at least a part of a directed graph of operations. In a directed graph neural network a large image may be broken up into smaller portions with a sub-process being generated for each portion of the overall image.

In some examples, the request is provided in a hardware agnostic manner. That is, the same request can be issued to a different cluster CPU with different tile CPUs and can still be performed (presuming that the tile CPUs are capable of performing the overall process if suitably instructed).

In some examples, the machine learning process is defined as a single combined process. The machine learning process is therefore not decomposed prior to being issued.

In some examples, the data processing method comprises providing an indication to a host CPU that at least one of the cluster CPU and at least one of the plurality of tile CPUs are available. In these examples the host CPU, which issues the request, is informed that the cluster CPU and one of the tile CPUs are available and therefore able to act on a request for a machine learning process to be performed that is issued from the host CPU. The indication of availability can differ between different examples. In some examples, this indicates that the host CPU and tile CPU are immediately able to perform the machine learning task. In other examples, this indicates that the host CPU and the tile CPU are able to receive the machine learning task in the expectations that they will be able to perform it within some predetermined period—but not necessarily that they can perform it immediately. In some examples, the availability also provides an indication that sufficient resource exists. For instance, if only a single low capability tile CPU is available then the indication may be that there is no available for a large, intensive machine learning task to be performed. Similarly availability may be contra-indicated for machine learning tasks where specialised resources are in-use and/or unlikely to become usable within a predefined period.

In some examples, the data processing method comprises: determining one or more capabilities of the tile CPUs to form a set of capabilities. In these examples, the capabilities of the tile CPUs (e.g. processing power, memory, etc.) are gathered in order to provide the set of capabilities across the set of tile CPUs. Such information can be used for reporting availability as well as for task managing and balancing.

In some examples, the data processing method comprises: determining one or more capabilities of the cluster CPU to add to the set of capabilities. In addition to considering the capabilities of the tile CPUs, the capabilities of the host CPU may also be added to the capabilities set.

In some examples, the data processing method comprises: decomposing the machine learning process based on the set of capabilities into a set of sub-processes to be allocated for execution across the cluster CPU and the tile CPUs. The decomposition process may, for instance, be performed by the cluster CPU. The capabilities can be used so that a particular tile CPU is not given a sub-process that it is unable to perform, or is unable to efficiently perform.

In some examples, the data processing method comprises: decomposing the machine learning process into a set of sub-processes to be allocated for execution across the cluster CPU and the tile CPUs. Those sub-processes that are executed on the second-level CPUs may include pre-processing sub-processes and/or post-processing sub-processes for instance.

In some examples, the sub-processes comprise at least one pre-processing sub-process executed on the cluster CPU to prepare workloads for allocation.

In some examples, the data processing method comprises: distributing at least a portion of the set of sub-processes among the tile CPUs; and further decomposing, at the tile CPU, the at least a portion of the set of sub-processes to generate a plurality of asynchronous tasks to be executed at the accelerators. In these examples, the sub-processes that are decomposed from the machine learning process are further broken down (e.g. by the tile CPUs) into asynchronous tasks that can be provided to the accelerators connected to the tile CPUs. The tasks are asynchronous in respect of the tile CPUs.

In some examples, the further decomposing also causes the at least a portion of the set of sub-processes to generate a pre-processing task that is executed on the tile CPU.

In some examples, the data processing method comprises: obtaining an indication of a result, an intermediate result, or a partial result of the machine learning process: from the accelerator at the respective tile CPU and/or from each of the tile CPUs at the cluster CPU. Depending on the decomposition that takes place, each of the tile CPUs may produce a result, an intermediate result, or a partial result of the machine learning process. These are then collected by the cluster CPU, which performs amalgamation and may thereby perform further decomposition of tasks to the tile CPUs.

In some examples, the data processing method comprises: obtaining a tile intermediate result from the accelerator at the respective tile CPU; and using the tile intermediate result from each of the tile CPUs to generate a cluster intermediate result. This may therefore be performed as part of a post-processing operation.

In some examples, the cluster intermediate result is generated using the tile intermediate result from the accelerator over a plurality of epochs. The offloaded machine learning process can therefore execute over a number of epochs or iterations without necessarily requiring further input from the host CPU.

In some examples, the data processing method comprises: obtaining a cluster intermediate result from each of the tile CPUs at the cluster CPU; and using the cluster intermediate result from each of the tile CPUs to generate a result. The cluster intermediate results could, for instance, be results of sub-processes performed on the tile CPUs. The cluster intermediate results can then be collected by the cluster CPU in order to produce an overall result, which may itself still be an intermediate result of the machine learning process. For instance, this overall result may be the overall result for a single epoch of a training process or it may be an overall result for a portion of data in an inference process (e.g. a tile in an image).

In some examples, the result is generated using the cluster intermediate result from each of the tile CPUs over a plurality of epochs. The result that is produced for the machine learning process is therefore generated over a number of iterations.

In some examples, the data processing method comprises: providing an indication of a final result to a host CPU. The indication of the final result of the machine learning process can therefore be provided (e.g. in the form of the result itself or a pointer to where the result can be found) to the host CPU (also referred to as a first-level CPU), which may have initially issued the machine learning process.

In some examples, the cluster CPU is configured to obtain the request to perform the machine learning process from a host CPU. The host CPU (also known as a first-level CPU) can be connected to the cluster CPU via an interconnect or bus. The interconnect or bus may also provide access to a common shared memory. The request can be issued by directly sending it from the host CPU to the cluster CPU (e.g. as part of a signal) or could be written to the shared memory and accessed by the cluster CPU as its convenience.

In some examples, the host CPU and the cluster CPU run separate operating systems.

In some examples, the request is issued to the cluster CPU and is handled by a cluster machine learning framework executing on a cluster operating system of the cluster CPU. In some examples, the framework is ‘compiled away’ at compilation time. However, in these examples, the framework runs as a service under the operating system of the second-level CPU making it possible for requests to be received dynamically. In some examples, the issuing the request to the cluster CPU occurs via an API operating on a host operating system on the host CPU.

In some examples, the request comprises an indication of the machine learning process to be performed and an indication as to the data on which to operate the machine learning process. The request may comprise an indication of the model to be used. The model may comprise a machine learning architecture such as a neural network architecture and may include one or more weights (although these may be initially excluded as part of a training process). The input data may comprise training data that used to perform training or could comprise application data that is applied to the model in order to produce a result.

In some examples, the machine learning process comprises a training process; and the definition comprises an indication of one or more training parameters. Training parameters can be used to not only confine the extent of the training, but also to define how the training should proceed.

In some examples, the one or more training parameters comprise an indication of an error function. The error function can be provided as a location in code where particular code is to be executed.

In some examples, the request comprises an indication of one or more cluster instructions configured to be executed on the cluster CPU. Another technique that can be used for providing the request is to provide cluster instructions that are executed by the cluster CPU. As with other transmissions described here, this could be achieved by providing the actual instructions or could be achieved by providing a pointer to where the instructions are executed. By providing the request in this way, it is possible for arbitrary code to be executed on each of the cluster and tile CPUs without resorting to particular pre-programmed techniques.

In some examples, the one or more second-level instructions cause execution of one or more asynchronous tasks. The cluster CPU may therefore cause the asynchronous tasks to be executed on each of the third-level CPUs.

In some examples, the model is encrypted using a key; and the key is held in a trusted execution environment accessible to at least one of the cluster CPU and the tile CPUs and inaccessible to the host CPU. The model (e.g. architecture and/or weights and/or biases) may not be accessible to the host CPU and may instead be encrypted. A trusted execution environment can be provided to the cluster CPU and/or the tile CPUs that enable the model to be used. This makes it possible for the detail of the model to be obfuscated and kept private.

Specific examples are now described with reference to the drawings.

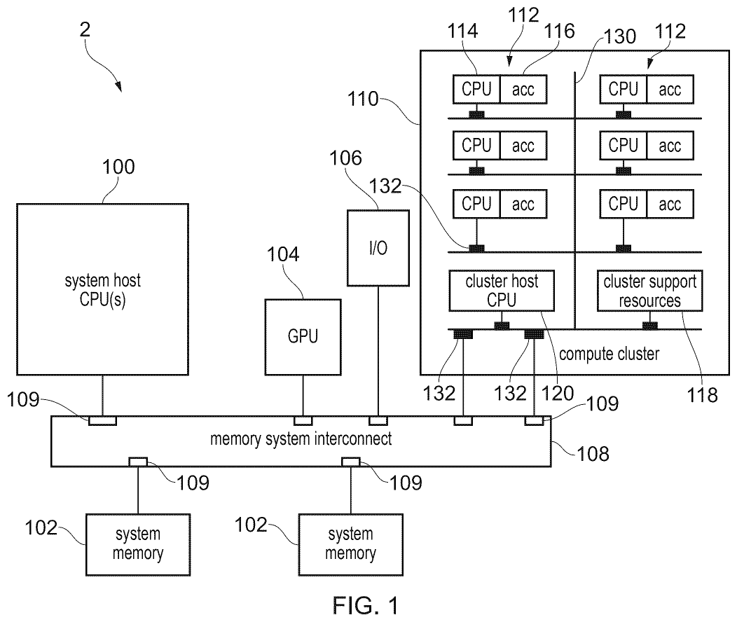

FIG. 1 schematically illustrates an example of a compute system 2, which may for example be an integrated circuit (e.g. system-on-chip) or a packaged chip comprising one or more chiplets. The system 2 comprises a system host CPU 100, which acts as the central control point for coordinating operations performed by other portions of the system 2. The system host CPU 100 could in some examples be a single CPU and in other examples implemented as a cluster of CPUs. For conciseness, references to the system host CPU 100 below are in the singular but encompass a cluster of multiple CPUs. The system host CPU 100 supports a general-purpose instruction set architecture (e.g. 64-bit architecture) capable of running general purpose user applications, operating systems and hypervisors. The system host CPU 100 has access to main system memory 102 via a primary memory system interconnect 108, with the system host CPU 100 being coupled to at least one endpoint 109 of the primary interconnect 108. The main system memory 102 is shared with one or more other memory access requesters 104, 106, 110 which are also coupled to other endpoints 109 of the primary interconnect 108. Those other requesters in this example comprise a graphics processing unit (GPU) 104, one or more input/output devices 106 (peripherals), and a compute cluster 110 provided for acceleration of particular classes of operations, such as operations for accelerating processing of machine learning models.

The compute cluster 110 comprises a sub-compute-system within the larger host compute system 2, and comprises further CPUs 120, 114 and accelerators 116. The compute cluster 110 comprises a number of compute tiles 112, each tile 112 comprising a tile CPU 114 and a corresponding hardware accelerator 116. The compute tiles 112 are coupled via a tile cluster interconnect 130 (e.g. a coherent mesh network), the tile cluster interconnect 130 being a secondary interconnect 130 which itself is coupled to one or more endpoints 109 of the primary memory system interconnect 108. For example, each tile CPU 114 and accelerator 116 may be coupled to one or more respective endpoints 132 of the secondary (tile cluster) interconnect 130, or alternatively the accelerator 116 may access the interconnect 130 via the corresponding tile CPU 114's endpoints.

The accelerators 116 may support hardware acceleration of any class of processing functionality that can benefit from more dedicated hardware support to improve performance for accelerated functions compared to implementations using general purpose instructions executing on general purpose hardware of the system host CPU 100. Examples of functionality that could benefit from acceleration may include cryptographic algorithms, data compression/decompression algorithms, or digital signal processing. However, in one particular example the compute cluster 110 may be intended for acceleration of operations for implementing machine learning processing, e.g. for implementing the training and/or inference phase of a machine learning model. For example, the accelerators may be artificial intelligence (AI) accelerators 116, e.g. a neural engine for accelerating processing of neural networks. Unlike operations performed synchronously by a CPU pipeline, the accelerator operations performed by the accelerator are performed asynchronously with respect to the CPU pipeline, yielding results at arbitrary timings relative to the instruction pipeline timings of the CPU pipeline.

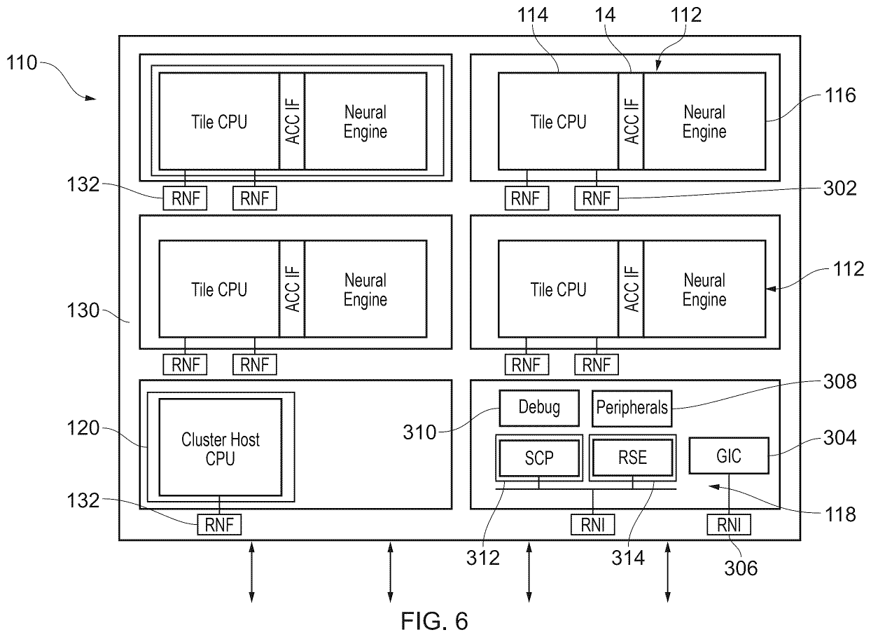

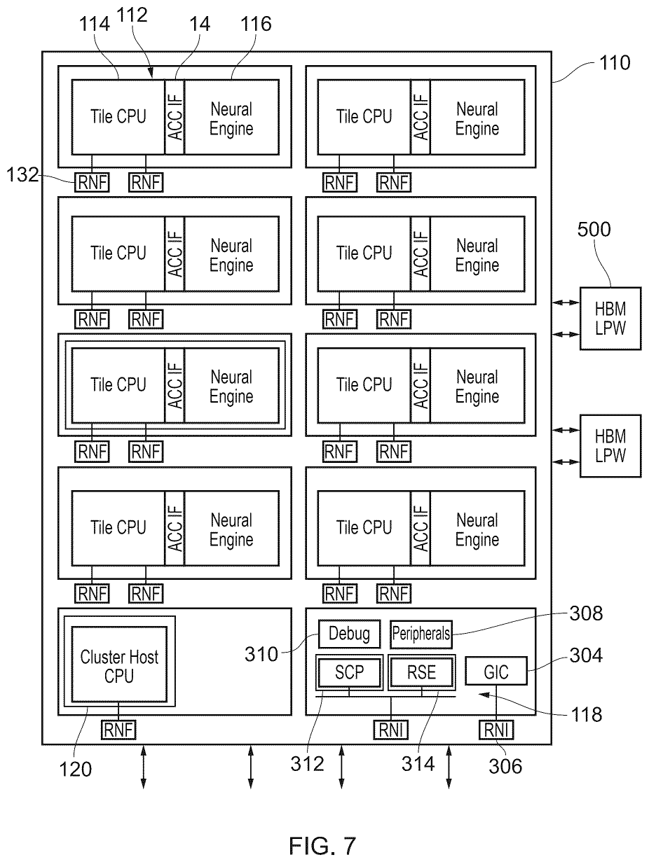

The compute cluster 110 also includes various cluster support resources 118, which provide auxiliary functions supporting the operations of the compute tiles 112. Specific examples of cluster support resources 118 are described in more detail with respect to FIGS. 6 and 7.

In addition to the compute tiles 110 comprising CPU-accelerator pairs, the compute cluster 110 also includes a cluster host CPU 120, which lacks a corresponding accelerator 116. The cluster host CPU 110 provides additional compute capacity for executing programs for managing accepting job requests from the system host CPU 100, decomposing the job requests into smaller sub-tasks and offloading the sub-tasks to individual tile CPUs 114. By providing a cluster host CPU 120 which can take responsibility for managing the delegation to individual compute tiles 110, with the tile CPUs 114 then taking responsibility for the low-level accelerator-specific commands issued to the corresponding accelerators 116 and associated accelerator control functions such as polling for completion of an accelerator task, this can greatly alleviate the burden on the system host CPU 104 accelerator control and allow a software stack such as a machine learning framework to be offloaded by the system host CPU 100 at a much higher level than would be possible if the compute cluster 110 was replaced by a standard hardware accelerator without the “smart” capability offered by the cluster host CPU 120 and tile CPUs 114. Also, by providing the cluster host CPU 120 in addition to the tile CPUs 114, then while the tile CPUs 114 are managing corresponding accelerators 116 according to a previous compute task, the cluster host CPU 120 can be negotiating with the system host CPU 100 to obtain and pre-process a subsequent job request, so that a series of compute tasks to be performed can be pipelined to much greater extent than would be possible if either the system host CPU 100 had direct control of the accelerators 116 or the tile CPUs 114 had to perform both control of their corresponding accelerators 112 and communication with the system host CPU 100 to accept job requests from the system host CPU 100.

Hence, to software executing on the system host CPU 100, the compute cluster 110 simply appears to be an accelerator device with a memory-mapped control interface, but unlike classic accelerators coupled to the primary interconnect 109 which would typically require considerable overhead from software running on the system host CPU 100 to provide hardware-implementation-specific streams of low-level commands, in the example of FIG. 1 the compute cluster 110 has smart CPU capability (including CPUs supporting the ability to execute operating systems and/or portions of a machine learning framework), so that the system host CPU 100 can be abstracted from the detail of controlling specific accelerators 116. This can help to preserve performance for other user-visible applications running on the system host CPU 100 such as Internet browsers or video players.

At least the cluster host CPU 120, and optionally also the tile CPUs 114, may be fully-featured processors supporting relatively high-end general purpose instruction sets (e.g. according to a 64-bit architecture—an architecture supporting memory addresses and register operands with greater than 64 bits), such that the cluster host CPU 120 (and in some examples also the tile CPUs 114) is capable of executing an operating system. This can help support operating models where the compute cluster 110 might execute a different operating system compared to the operating system supported by the system host CPU 100, which can be helpful in cases where a machine learning framework, say, is optimized for a particular operating system but the system host CPU 100 is to support a different operating system.

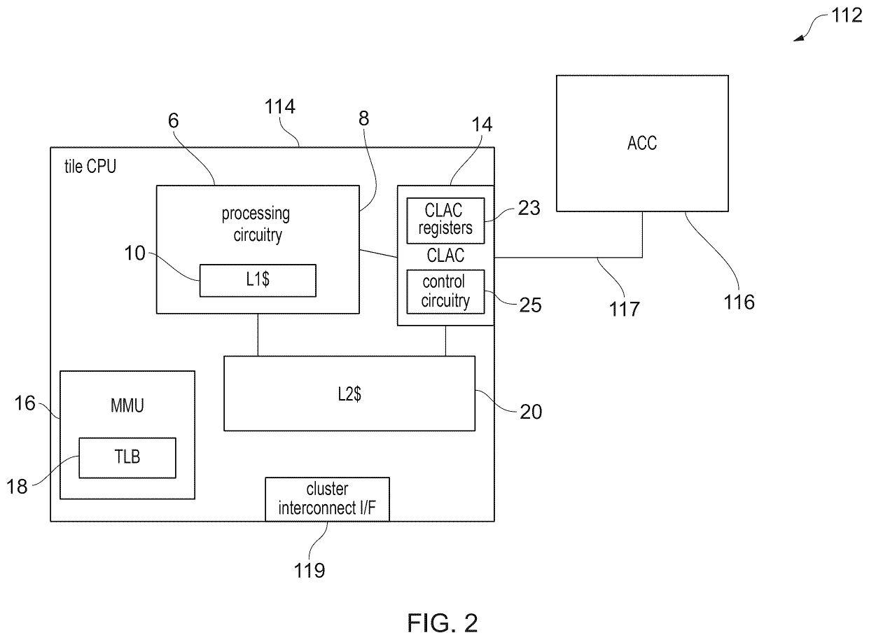

For a given compute tile 112, the accelerator 116 may be tightly coupled to the 5 tile CPU 114. The tile CPU 114 and accelerator 116 may communicate via an accelerator control interface 14 over a signal path 117 (shown in FIG. 2) which is separate from the interface by which the tile CPU 114 accesses memory via the secondary interconnect 130. This allows for fast offloading of delegated functions from the tile CPU 114 to the accelerator 116, compared to an implementation where accelerator commands from the tile CPU 114 and the accelerator 116 have to contend for bus bandwidth on a memory interconnect shared with regular memory accesses by the tile CPU 114 to memory.

FIG. 2 shows in more detail an example of a compute tile 112 comprising a tile CPU 114 and an accelerator 116. While FIG. 2 shows a single accelerator 116 coupled to the tile CPU 114, other examples could provide more than one accelerator 116 per tile, with multiple accelerators coupled to the tile CPU 114 via the accelerator control interface.

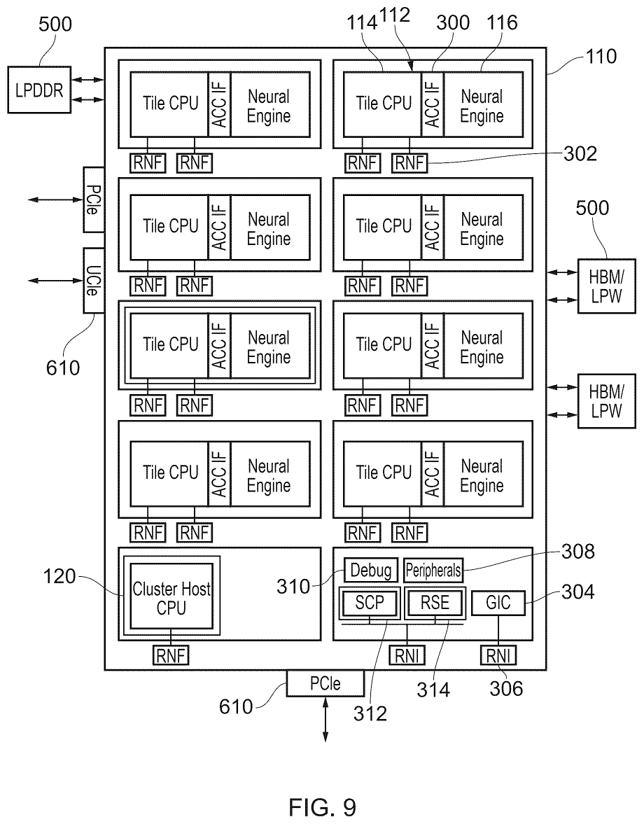

The tile CPU 114 comprises processing circuitry 6 to execute instructions defined in an instruction set architecture (ISA) to carry out data processing operations represented by the instructions. The processing circuitry 6 performs operations on data loaded from a memory system, and may store the results back to the memory system. In this example the memory system includes a level one cache 10, a level two cache 20, and memory (e.g. system memory 102 of the host system 2 to which the compute cluster 110 comprising the compute tile 112 is coupled, and/or cluster-private memory 500 as described with reference to later examples with reference to FIG. 7 or 9). However, it will be appreciated that this is just one example of a possible memory hierarchy and other implementations can have further levels of cache or a different arrangement. For example, separate level one caches 10 may be provided for instructions and data. The provision of caches 10, 20 within the CPU 4 enables faster access to data than from memory 24 (which can include on-chip and/or off-chip memory 24).
The CPU 4 also comprises a memory management unit 16 (MMU, an example of memory management circuitry), to perform address translation in response to memory access instructions executed by the processing circuitry. The MMU 16 translates virtual addresses specified by memory access requests into physical addresses identifying storage locations of data in the memory system. The MMU 16 has a translation lookaside buffer (TLB) 18 for caching address translation data from page tables stored in the memory system, where the page table entries of the page tables define address translation mappings and may also specify access permissions which govern whether a given process executing on the pipeline is allowed to read, write or execute instructions from a given memory region.

The compute tile 112 also includes one or more hardware accelerators 116 configurable, based on instructions executed by the processing circuitry 6, to perform a delegated task, asynchronously with respect to operations performed by the processing circuitry 6 of the tile CPU 114 in response to executed instructions.

The hardware accelerator 116 is unique (private) to a single tile CPU (core) 114, and therefore may be referred to as a core local accelerator (CLA). The hardware accelerator 116 is controlled by, and communicates with the memory system via, an associated processor core 114. The CPU 114 therefore comprises accelerator control interface circuitry 14 (a core local accelerator control module (CLAC)) to exchange control signals with the at least one hardware accelerator 22 via a signal path 117 distinct from the signal path via which a cluster interconnect interface 119 routes memory access requests from the tile CPU 114 to the secondary interconnect 130.
The hardware accelerator 116 accesses the memory system via the tile CPU 114, and issues accelerator-triggered memory access requests specifying virtual addresses. In response to an accelerator-triggered memory access request received at the accelerator control interface circuitry 14 from the hardware accelerator 114, the MMU 16 of the tile CPU 114 translates a virtual address specified by the accelerator-triggered memory access request to a physical address of a memory system location to be accessed in response to the accelerator-triggered memory access request. Hence, the hardware accelerator reuses the memory management circuitry 16 of the tile CPU 114 for address translation. The MMU 16 may translate the virtual address of an accelerator-triggered memory access request according to address mapping information associated with the virtual address and a given address translation context. The given address translation context may be an address translation context which was a current address translation context of the tile CPU 114 at the time of execution of an instruction which caused launch of an accelerator command which caused the accelerator-triggered memory access request to be issued (e.g., the address translation context at the time a task was delegated), and hence may be a different address translation context to a current address translation context of the processing circuitry 6. The CLAC interface 14 may have storage to capture an indication of the current translation context at the time when commands are launched to the accelerator 116, to record the context in which subsequently received accelerator commands are to be managed for the purpose of address translation.
In some examples, address translation faults arising from translation of accelerator-triggered memory accesses may be handled differently to faults arising from translation performed in response to memory access instructions executed by the processing circuitry 6 of the tile CPU 114. In particular, faults arising from translation of accelerator-triggered memory accesses may be signalled to the hardware accelerator 116 which issued the request and may not trigger an exception, enabling fault handling for those accesses to be deferred until a point at which the software running on the tile CPU 114 is the software which configured the accelerator 116 to perform the delegated task which encountered the address translation fault for one of its memory accesses.

The accelerator 116 may also have access to one or more private caches (e.g. the level 2 cache 20) of the tile CPU 114 (caches which are not shared with any other CPU). This can allow more efficient sharing of data between the tile CPU 114 and accelerator 116 compared to sharing of data via memory.

As the accelerator memory accesses specify virtual addresses in the same address translation context as the software process which configured the accelerator 116 to carry out a function which causes those memory accesses to be requested (rather than accelerator specifying physical addresses directly), it becomes possible for the accelerator 116 to be configurable in an operating state of the tile CPU 114 having user-level privilege (the lowest level of privilege granted to user-level application code), rather than requiring the accelerator to be configured only by more privileged code such as an operating system or hypervisor, since the MMU 16 may enforce permissions on the accelerator 116 based on permissions defined in translation tables. This can improve performance by reducing the need for application-level code to call into an operating system or hypervisor when it needs the accelerator to perform delegated tasks.

In some examples, the processing circuitry 6 may support execution of instructions of an ISA providing a class of accelerator control instructions, separate from load/store instructions, for controlling the accelerator interface circuitry 14 to perform functions such as launching accelerator commands, checking on accelerator status, reading internal accelerator state, writing other accelerator control registers, etc.

However, in other examples, the tile CPU 114 may comprise memory-mapped register storage 23 accessible in response to load/store instructions executed by the processing circuitry 6 specifying target addresses mapped to the memory-mapped register storage. Hence, accelerator commands may be triggered by execution of load/store instructions which specify addresses mapped to the memory-mapped register storage, illustrated in FIG. 1 as the “CLAC registers” 23 (CLAC referring to “core local accelerator control”). The tile CPU 114 (via the accelerator interface circuitry 14) may control operation of the at least one hardware accelerator 116 by writing to and reading from the memory-mapped register storage. Hence, the processing circuitry 6 can control operation of a hardware accelerator 116 using conventional load/store instructions (with the address of the load/store instructions distinguishing accelerator control instructions from other load/store instructions targeting locations in the memory system 10, 20, 102).

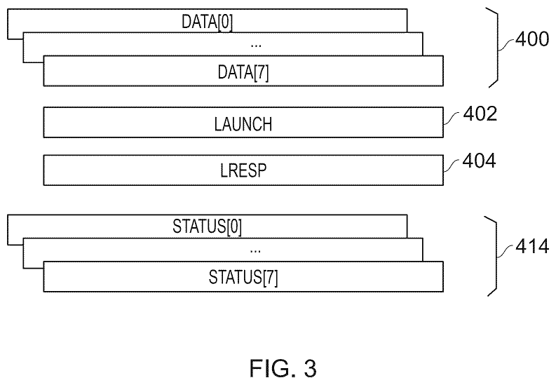

FIG. 3 schematically illustrates an example set of memory-mapped control registers 23 provided in CPU 4 for controlling operation of one or more core local hardware accelerators 114. It will be appreciated that further control registers not illustrated in FIG. 3 could also be provided. The physical address of each memory-mapped register can be derived by combining a base address representing the start of a control structure mapped to the registers 23 with an offset associated with a particular memory-mapped control register. The base address may be a programmable parameter of the CLAC interface 14.

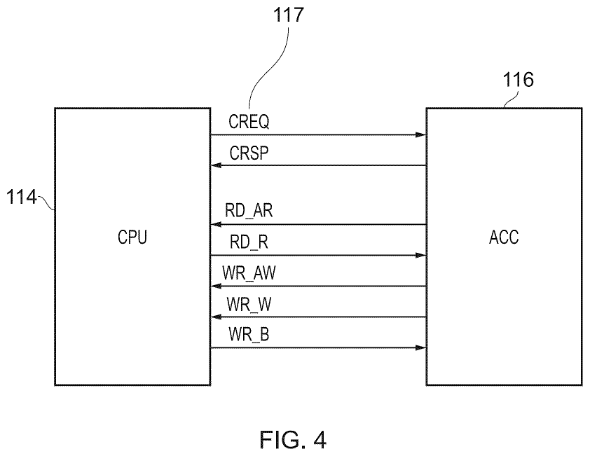

The set of memory-mapped control registers 23 comprises a set of (e.g. eight) data port registers 400 (DATA). The DATA registers are used to store input and output parameters for control commands communicated between the tile CPU 114 and the hardware accelerator 116. The DATA registers 400 do not provide the main path for communicating processing data between the memory system and the hardware accelerator 116. As shown in FIG. 4, the physical signal paths 117 between the tile CPU 114 and accelerator 116 may include a number of communication channels, which may include (at least) two groups of channels: control channels and memory interface channels. The memory interface channels comprise a read address channel (RD_AR), a read data channel (RD_R), a write address channel (WR_AW), a write data channel (WR_W), and a write response channel (WR_B). In some examples, multiple read and/or write channels may be supported, and hence for example two or more copies of the RD_AR and RD_R channels may be provided, and so on. For example, the memory interface channels may be implemented according to the AXI protocol provided by Arm® Limited. On the other hand, the control channels are used for launching accelerator commands to the accelerator 116, checking accelerator status, etc, or for any other request/response not related to an accelerator-triggered access to memory.

Hence, the DATA registers 400 are provided to enable parameters to be specified by software for control commands for controlling the hardware accelerator 116. Contents of the DATA registers 400 may be transferred to the accelerator 116 alongside launched accelerator commands transmitted via the control request channel, and certain commands may prompt the accelerator 116 to return parameters via the control response channel with the parameters then being written to the DATA registers 400 from which those parameters can be read by software executing on the tile CPU 114.

The set of memory-mapped control registers 23 also comprises a LAUNCH register 402. Processing circuitry 6 can cause accelerator control signals to be issued to a given hardware accelerator 22 by writing to the LAUNCH register 402, which triggers control circuitry 25 to generate the corresponding control signals. Writing different values to the LAUNCH register indicates that the processing circuitry 6 requests the hardware accelerator control interface circuitry 14 to initiate different operations for performance by the hardware accelerator 22 (e.g. a field within the LAUNCH register 402 may be encoded to represent the type of command being instructed). For example, command encodings may include a command which requests that the accelerator starts a new delegated task, a register read/write command for reading or writing accelerator registers provided within accelerator 116, pause/resume commands to instruct the accelerator to pause its current task or resume after previously pausing, or save/restore commands for instructing the accelerator to save internal state information to memory or restore previously saved internal state from memory. It will be appreciated that the particular commands supported may vary depending on implementation. Also, it will be appreciated that in some cases the command encodings in the launch register 402 may be generic to a wide variety of specific hardware accelerator implementations (e.g. the launch register may support a generic “command launch” command), and the actual implementation-specific commands to a particular implementation of an accelerator may be encoded using the contents of the data registers 400 which are to be transmitted as parameters alongside a launch command.

The set of memory-mapped control registers 23 also comprises a launch response LRESP register 404. The LRESP register 404 is used to indicate a response to a previous write to the LAUNCH register 402. For example, the LRESP register 404 may specify a response pending field used to indicate whether the accelerator is still to respond to a previous command launched via the LAUNCH register 402. A response is pending if an operation has been signalled to a given hardware accelerator but a response to that signal has not yet been received. If software polls the LRESP register when the pending indication is set, this may indicate that the software should try again later as the contents of the other fields cannot be relied on. Other fields of the register may provide status codes indicating the status of the previously launched command, such as an indication of whether any error occurred, whether a timeout was detected where the accelerator did not respond within a given time period, or whether the accelerator is currently unavailable (e.g. because the accelerator is busy carrying out a task for another software process running on the tile CPU 114). If the response to an accelerator command indicated by the LRESP register indicates that the command has not been accepted, the software executing on the tile CPU 114 may retry the accelerator command later. If the accelerator command has successfully been accepted, then the software on the tile CPU 114 can stop polling the LRESP register and await completion of the task offloaded to the accelerator, which is completed asynchronously by the accelerator (so the instruction which caused the accelerator command to be issued can commit on the processing pipeline of the tile CPU 114 without waiting for completion of the offloaded task).

The set of memory-mapped control registers 23 also comprises a set of status reporting registers STATUS [0:7] 414. Unlike the other registers 400 to 412, which are shared between hardware accelerators, the STATUS registers are each unique to a particular hardware accelerator 116 (hence if there is only one hardware accelerator 116 per tile 112, only a single status registers 414 could be provided on each tile). Each STATUS register 414 is used to report information about a corresponding hardware accelerator 116 to the CPU 4. For example, the status information may include an indication of whether the accelerator is idle (which can be an indication that a previously offloaded task has completed), whether the accelerator is ready to accept further commands, whether a memory translation fault has been detected during the handling of a previously accepted accelerator command, etc. Hence, the software on the CPU 114 can poll the status register 414 for a given accelerator 116 to identify when the task assigned to that accelerator 116 is complete or to identify errors which have arisen during processing of the task. Once the task is complete, the data processed by the accelerator 116 can be retrieved from memory (either by the tile CPU 114 itself, or by another CPU, e.g. the cluster host CPU 120).

Hence, while the tight integration of the accelerator 116 into the tile CPU 114 as in the example of FIG. 2 can be helpful to reduce communication delays between tile CPU 114 and accelerator 116, nevertheless control of the accelerator 116 may rely on software writing specific data values in a particular encoding to the CLAC registers 23 and implementing loops to poll the CLAC registers 23 to check for command acceptance and task completion. This low-level accelerator control overhead can be onerous for software executing on a given CPU 114 and may be highly disruptive for other software executing on that CPU 114. This is one reason why it can be extremely beneficial to be able to offload such accelerator-specific control actions to the tile CPUs 114 so that the cluster host CPU 120 (executing higher level machine learning framework functionality) and the system host CPU 100 (which may be executing user-visible applications such as video players or internet browsers) do not get bogged down with low-level accelerator commands.

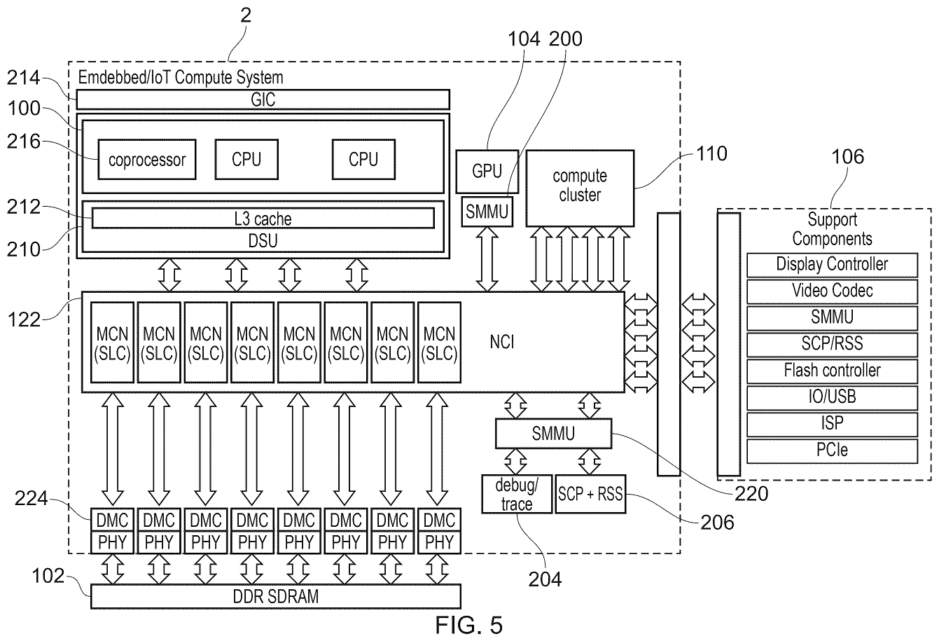

FIG. 5 shows a more detailed example of an embedded compute system 2 comprising the compute cluster 110. The system host CPU 100 in this example comprises a cluster of processor cores (primary CPUs) and also comprise at least one coprocessor 216 for processing a certain class of functions (e.g. matrix processing operations). Unlike the accelerators 116, the operations offloaded to the coprocessor 216 are processed synchronously with respect to other operations, such that a given instruction executed on the coprocessor 216 is committed at a point when its result is available, and instructions on the main CPU pipeline(s) which depend on an instruction executed on the coprocessor 216 are deferred from being committed until the coprocessor operation itself is committed. For at least arithmetic/logical instructions executed by the coprocessor 216, a result of a given instruction is available within a given number of cycles of the instruction being launched (as opposed to arithmetic/logical functions carried out asynchronously by an accelerator 116 for which the result is not guaranteed to be completed in any particular number of cycles). As well as any private caches (not shown in FIG. 5) which are private to a particular CPU of the system host CPU cluster 100, the system host CPU 100 also comprises a shared level 3 cache 212 shared between cores of the cluster 100. For example, the level 3 cache 212 may be provided within a shared unit (DSU) 210 which provides a coherent interconnect managing a coherency protocol to maintain cache coherency between the CPUs in the system host CPU cluster 100. The system host CPU cluster 100 is also associated with an general interrupt controller (GIC) 214 for controlling interrupt handling in response to external interrupts.

The CPU cluster 100 is coupled to a non-coherent interconnect 122 (acting as the primary memory system interconnect 108 in this example), which also has endpoints coupled to the GPU 104, compute cluster 110 and memory controllers 224 corresponding to main system memory 202 (e.g. DDR SDRAM). The compute system 2 may also include other components coupled to the interconnect 122, such as debug/trace units 204 for providing diagnostic functionality and one or more auxiliary processors 206 such as system control processor (SCP) for providing system initialization functions at boot time and/or runtime security subsystem (RSS) for providing secure functions such as encryption. Some components, such as the GPU 104, debug/trace unit 204 and SCP/RSS 206 may communicate with the interconnect 122 via a system memory management unit (SMMU) which performs address translation functions for memory access requests issued by those components.

Also, various support components 106 are coupled via an interface to the primary memory system interconnect 122. While FIG. 5 shows these support components as external to the compute system 150 (e.g. implemented on a different chiplet), these could also be implemented on the same chip as the rest of the compute system 2. The support components 106 could include various resources such as a display controller, flash controller, other I/O or USB controllers, or other I/O devices coupled to an I/O interface such as a PCIe interface, as well as including further resources such as a SMMU, SCP or RSS etc.

The compute cluster 110 is coupled to one more endpoints of the primary interconnect 122. It is possible to provide multiple primary interconnect endpoints corresponding to the compute cluster 110, to increase memory access bandwidth between the compute cluster 110 and memory 202, which can be helpful given the data-intensive operations such as machine learning processing expected to be handled using the compute cluster 110.

FIG. 6 shows more detail for an example of the compute cluster 110, in this case comprising four compute tiles 112 each having a tile CPU 114 and a corresponding accelerator (e.g. neural engine) 116 coupled to the tile CPU 114 via the accelerator control interface 14 mentioned earlier. The compute cluster comprises a coherent mesh network 130 acting as the secondary interconnect described earlier, which has a number of secondary interconnect endpoints 132 via which requesters can request memory access requests to be transmitted on the bus and completers can respond to those access requests. Each compute tile may be coupled to one or more secondary interconnect endpoints 132, e.g. two endpoints 132 per compute tile 112 in this example. By providing multiple endpoints per tile, this can increase memory access bandwidth per tile compared to a single endpoint (as each endpoint may have a limited bandwidth). As mentioned above, the accelerator (e.g. a neural engine) 116 of a given compute tile 112 accesses memory via the tile CPU 114 and the corresponding endpoints 132 of the secondary interconnect 130. While not shown in FIG. 6, each compute tile 110 may also be associated with a system cache (provided at system level within the secondary interconnect 130), which can be accessed in a shared manner by multiple compute tiles. By providing at least one instance of a system cache per compute tile 110, a large amount of internal cache capacity can be provided within the compute cluster 110 at system level, to speed up access to recently accessed data.

The cluster host CPU 120 is similarly coupled to at least one endpoint 132 of the secondary interconnect 130. The cluster host CPU 120 may have fewer endpoints 132 than a given tile CPU, to reflect that the memory bandwidth required by the cluster host CPU 120 may be lower than for the tile CPUs 132 (as the cluster host CPU 120 does not have any associated accelerator 116). The cluster host CPU 120 could support the same ISA as the tile CPUs 114 (e.g. both types of CPU supporting an N-bit architecture (N>32), e.g. a 64-bit architecture, capable of execution of operating systems and arbitrary general purpose user applications). It can be useful to provide a general purpose CPU as the tile CPU to enable emulation of machine learning functions or data types not supported by the neural engine 116. The cluster host CPU 120 may run (in some examples, cooperatively together with the tile CPUs 114) a cluster operating system which may be the same as, or different to, the host system operating system running on the system host CPU 100.

In some examples, the tile CPUs 114 on the compute tiles 112 may be provided with greater interconnect bandwidth on the secondary interconnect 130 compared to the bandwidth allocated for the cluster host CPU 120. For example, as shown in FIG. 6, each compute tile 112 may have a greater number of secondary interconnect endpoints 132 than the cluster host CPU 120, to increase the bandwidth available for the expected data-intensive operations performed by the compute tile 112. Other techniques (e.g. quality of service management) can also be used to reserve additional bandwidth for the compute tiles 110 compared to the cluster host CPU 120.

The cluster support resources 118 mentioned earlier are shown in more detail in FIG. 6. For example, the cluster support resources 118 may comprise a debug unit 310, a SCP (system control processor) 312, which is responsible for boot/initialization functions and/or power control of resources within the compute cluster), a RSE (runtime security engine) 314 for performing functions such as authentication/attestation that the cluster meets predefined security criteria and debug authentication, peripherals 308 and a generic interrupt controller 304. Hence, from comparison with FIG. 5 it can be seen that the compute cluster can be seen as a “compute system within a compute system” (the compute system may be capable of executing operating system or application code entirely independently of any direction from the system host CPU).

As shown in FIG. 7, the modular nature of the compute cluster 110, being formed of a variable number of compute tiles of logically similar design, means that the compute cluster 110 can easily be scaled to different performance requirements, by varying the number of compute tiles 110 provided in the cluster. When the system is scaled to higher computational power (e.g. by doubling the number of compute tiles as shown in the transition from FIG. 6 to FIG. 7), it may be that there becomes a bottleneck in accessing main system memory 202. Hence, it can be useful to provide cluster memory storage 500 coupled to the cluster interconnect 130, which is accessible to the cluster host CPU 120 and tile CPUs 114 of the compute cluster 110. The cluster memory storage 500 may be accessed with lower latency by the tile CPUs 114 compared to access to main system memory. The cluster memory storage 500 may be inaccessible to the system host CPU 100. For example, the cluster memory storage circuitry 500 may comprise high-bandwidth memory (HBM) or low power wide I/O memory (LPW memory). By providing dedicated high-bandwidth capacity-constrained memory for high-tile-count configurations, this reduces the memory bandwidth burden on the host system, preserving memory system performance for the system host CPU 100.

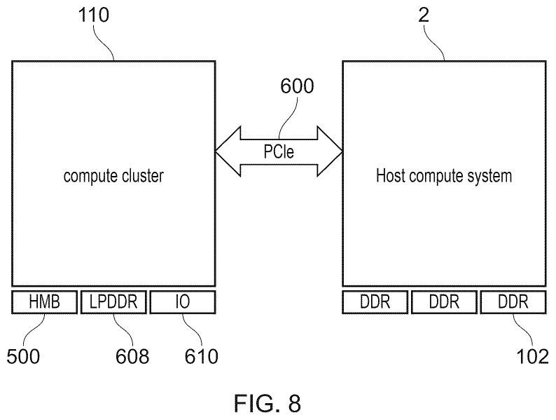

In the examples discussed above, the compute cluster 110 is a component embedded within the host system 2. However, it is also possible to provide the compute cluster 110 as a standalone component (e.g. a chiplet) which may communicate with the host compute system via a peripheral interface (e.g. PCIe) 600 as shown in FIG. 8, or alternatively via an inter-chiplet interface such as UCIe. Hence, in this case the communications between compute cluster 110 and host compute system 2 may be according to an I/O protocol such as PCIe or UCIe rather than being directly coupled to the main memory system interconnect of the host system 2. Hence, it is not essential for the compute cluster 110 to be implemented on the same integrated circuit as the host compute system 2.

As shown in FIGS. 8 and 9, when the compute cluster 110 is implemented on a separate integrated circuit to the rest of the host system 2, the endpoint connections to the primary memory system interconnect of the 108 of the host system 2 may be replaced with a PCIe or UCIe interface or other peripheral/inter-chiplet interface (e.g. a PCIe interface 610 in the example of FIG. 9), and the compute cluster 110 may be provided with a number of instances of on-board cluster memory storage 500, e.g. HBM/LPW memory and/or instances of DDR SDRAM (double data rate synchronous dynamic random access memory) as shown in FIG. 9), to alleviate the pressure on the peripheral/inter-chiplet interface by enabling more data to be stored locally within the compute cluster 110. Otherwise, the compute cluster 110 may have a similar configuration to the earlier examples embedded into the host system, with the same tiled arrangement of compute tiles 112 and the cluster host CPU 120.

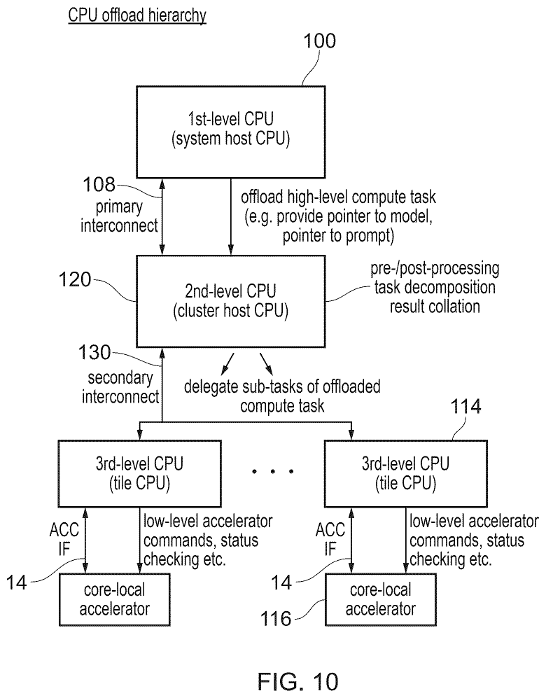

FIG. 10 illustrates an example of a CPU offload hierarchy which may be implemented within a compute system such as a system 2. The offload hierarchy includes a number of levels of CPU, where a higher level CPU in the hierarchy is responsible for offload of processing tasks to a lower level CPU in the hierarchy. Hence, the CPU offload hierarchy includes a first-level CPU (e.g. the system host CPU) 100, a second-level CPU (e.g. the cluster host CPU) 120, and a cluster of third-level CPUs (e.g. the tile CPUs) 114. The first-level CPU 100 and second-level CPU 120 communicate via a primary interconnect 108. On the other hand, the second-level CPU 120 and third-level CPUs 114 communicate via a secondary interconnect 130. In some examples, the second-level CPU 120 may not have direct access to the primary interconnect 108 but may access the primary interconnect 108 via the secondary interconnect 130.

The first-level CPU 100 is considered to be higher in the hierarchy than the second-level CPUs 120, such that the first-level CPU 100 offloads high-level compute tasks (e.g. a higher layer of a machine learning framework) to the second-level CPU 120. For example, the first-level CPU 100 may, when controlled by software, provide a pointer to machine learning framework code and a pointer to the prompt or input data to be processed using the framework.

The code executing on the second-level CPU 120 may perform various pre-processing functions for preparing input data for processing by the third-level CPUs in cooperation with their corresponding accelerators 116. The second-level CPU 120 may also decompose the high-level compute task offloaded by the first-level CPU 100 into sub-tasks to be performed on each third-level CPU 114. The second-level CPU 120 then delegates the sub-tasks to the respective third-level CPUs 114 within each compute tile 110. If the offloaded compute task involves training of a machine learning model, the second-level CPU 120 may also execute operations for determining, during a training phase of a machine learning model, whether a further round (epoch) of training should be performed on the third-level CPUs 114, or whether model performance following previously completed training is sufficient to give a model meeting the desired requirements. Hence, the offloaded task offloaded from the first-level CPU 100 to the second-level CPU 120 may involve multiple rounds of training (rather than being commands for a single training instance).

The third-level CPUs 114 are responsible for issuing of low-level accelerator commands to their corresponding accelerators 116 (e.g. the writes to the data registers 400 and launch control register 402 mentioned earlier), and can also perform launch response polling loops and status checking polling loops to check the launch response register 404 or status registers 414 for command acceptance by the accelerator and completion of the offloaded accelerator task.

Once an accelerated task performed by the third-level CPU 114 in conjunction with an accelerator 116 is complete, the completion of the task may be signalled (e.g. using a write to shared memory data) to software executing on the second-level CPU 120 which may collate results from multiple sub-tasks executing on respective third-level CPUs 114 and report the overall result completion to the first-level CPU 100 which can make the result available to the application which requested the originally offloaded high-level compute task.

Hence, with this programming model for a three-level CPU hierarchy, the software executing on the first-level CPU 100 is abstracted from the detail of specific machine learning frameworks and accelerator control, as pre-/post-processing functions, task decomposition and result collation can be performed on the second-level CPU 120 and accelerator-specific command sequences and polling loops can be performed on the tile CPUs 114. Also, the second-level CPU 120 is abstracted from the need to handle accelerator-specific command sequences and polling loops related to accelerator control, so can be freed up to negotiate accepting a further compute task from the first-level CPU 100 in parallel with the third-level CPUs 114 managing processing of previous compute tasks using the accelerators 116. Therefore, the three-level CPU hierarchy can be particularly beneficial to accelerating computation-intensive operations such as machine learning operations.

Concepts described herein may be embodied in a system comprising at least one packaged chip. The apparatus (e.g. the overall system 2, or a specific sub-component such as the compute cluster 110) described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

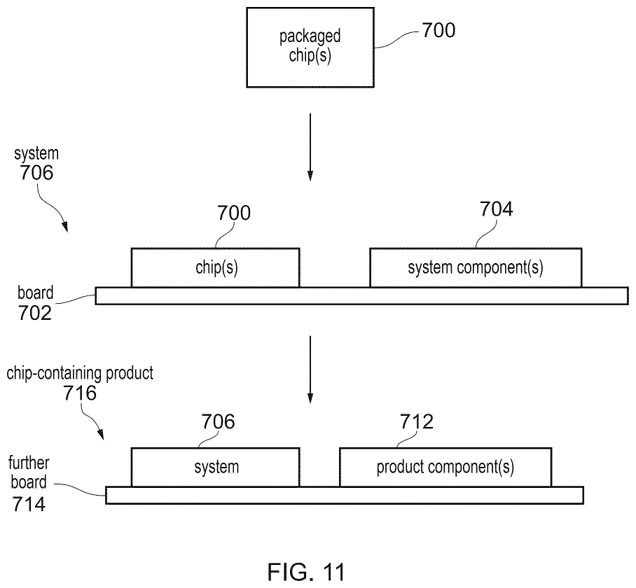

As shown in FIG. 11, one or more packaged chips 700, with the apparatus described above implemented on one chip or distributed over two or more of the chips, are manufactured by a semiconductor chip manufacturer. In some examples, the chip product 700 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 700 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 700 are assembled on a board 702 together with at least one system component 704 to provide a system 706. For example, the board may comprise a printed circuit board. The board substrate may be made of any of a variety of materials, e.g. plastic, glass, ceramic, or a flexible substrate material such as paper, plastic or textile material. The at least one system component 704 comprise one or more external components which are not part of the one or more packaged chip(s) 700. For example, the at least one system component 704 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 716 is manufactured comprising the system 706 (including the board 702, the one or more chips 700 and the at least one system component 704) and one or more product components 712. The product components 712 comprise one or more further components which are not part of the system 706. As a non-exhaustive list of examples, the one or more product components 712 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 706 and one or more product components 712 may be assembled on to a further board 714.

The board 702 or the further board 714 may be provided on or within a device housing or other structural support (e.g. a frame or blade) to provide a product which can be handled by a user and/or is intended for operational use by a person or company. The system 706 or the chip-containing product 716 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights. Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

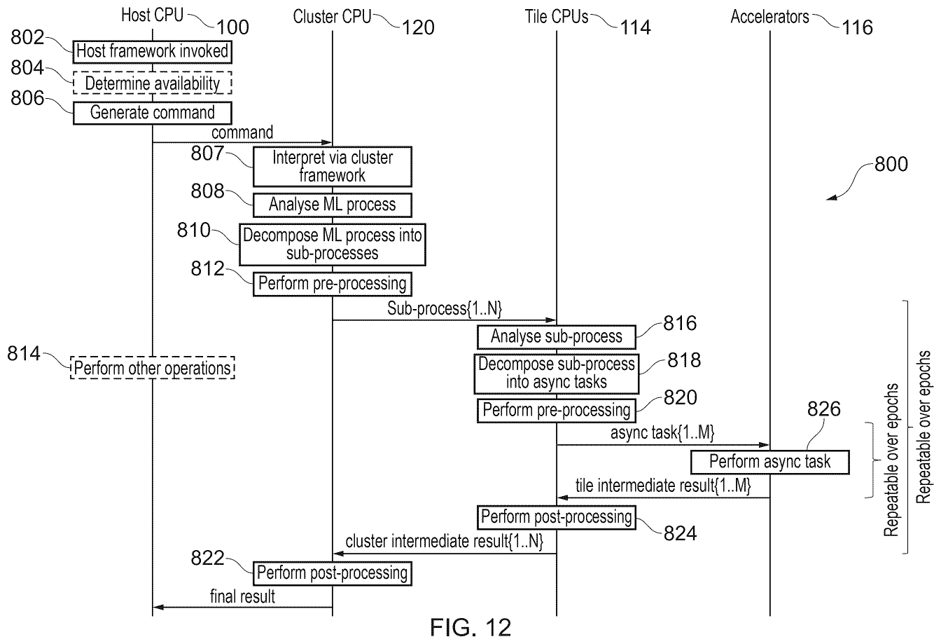

FIG. 12 illustrates how each of a host CPU 100, cluster CPU 120, tile CPUs 114, and accelerators 116 cooperate in order to cause a machine learning process to be offloaded from a host CPU, decomposed into a number of subtasks by a cluster CPU 120 and decomposed into asynchronous tasks by tile CPUs 114, which are executed by the accelerators 116.

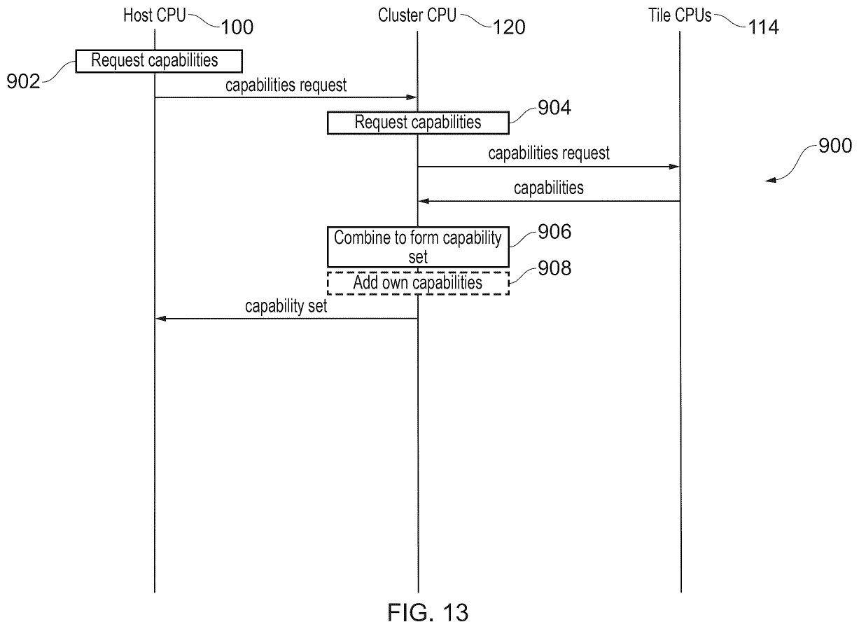

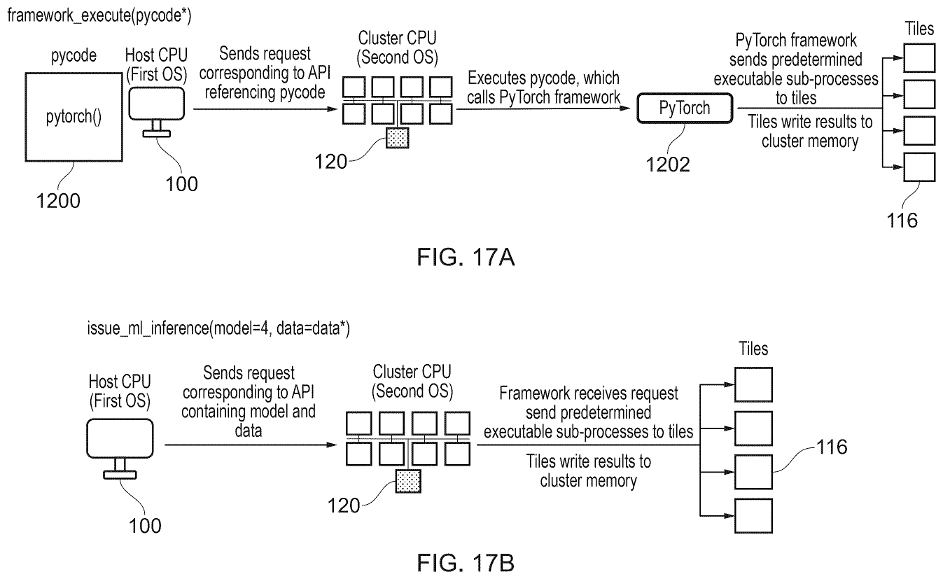

The process begins at step 802 where the host framework is invoked at the host CPU 100. The host framework may be invoked as a consequence of the host framework being a runtime, or the host framework could be compiled together with other source code as part of an executable. An optional step 804 causes availability of the cluster 110 and/or the cluster CPU 120 and/or the tile CPUs 114 to be determined. This is discussed in more detail with respect to FIG. 13. The host framework on the host CPU 100 then causes a command to be generated at step 806. The command is issued by the host CPU 100 to the cluster CPU 120. There are a number of forms that the command could take. Examples of the sort of commands that could be issued are illustrated with respect to FIGS. 17A and 17B.

The command is obtained by the cluster CPU 120. In particular, the command could be received having been transmitted along an interconnect or bus that connects the host CPU 100 to the cluster CPU 120. Alternatively, the command could be obtained from a shared memory 102. A combination of techniques can also be used in which, for instance, the cluster CPU 120 is notified via an interconnect or bus that a command has been issued and should be obtained from a shared memory 102. Regardless, the command that has been issued is interpreted via a cluster framework at step 806. At a step 808, the framework determines the machine learning process that has been requested by the host CPU 100. Up until this point, the machine learning process has been specified without reference to any particular hardware. Furthermore, the process has been specified without any sort of decomposition of the machine learning process having been specified. Thus, at step 810, the machine learning process that has been requested is decomposed into a number of sub-processes. At a step 812, pre-processing is performed. This preprocessing could involve the execution of one of the sub-processes into which the machine learning process has been decomposed. Another example of the pre-processing that may occur, maybe the initialisation or copying of data. For instance, data such as a model may be copied from a system memory 102 into dedicated memory of the cluster 110 where it can be accessed more quickly. Another example of pre-processing that may occur, could be the determination of particular operations that are to be performed. For example, this may include the determination of an error function or learning step size to be set during machine learning process. Each of the sub-processes 1 to N are then provided to the tile CPUs 114.

At the tile CPUs 114, a similar process is performed in which each sub-process is analysed at step 816 and decomposed into one to M asynchronous tasks at step 818. Once again, pre-processing may occur at step 820. This could be different from the pre-processing that occurs at step 812. The asynchronous tasks are then provided to accelerators 116 and at step 826, each of the asynchronous tasks is performed.

Execution of each asynchronous task, in this example, results in the generation of a tile intermediate result. These are gathered by each tile CPU 114. Post-processing may then be performed at step 824 this results in a cluster intermediate result being produced by each tile CPU and the cluster intermediate results can be provided to the cluster CPU 120. Once again, post-processing can be performed at step 822, and a final result then provided to the host CPU 100. In each case, the provision of results and intermediate results (which may also be partial results) can be transmitted along an interconnect or bus, or can be provided into a shared memory. Between the offloading of the machine learning process via the command and the receiving of the final result, the host CPU 100 is able to perform one or more other operations at step 814. This is of course entirely optional.

It will be noted that the issuing of the asynchronous tasks, the performing of the asynchronous tasks 826 and the providing of the tile intermediate results may be repeatable over a number of iterations or epochs. Similarly, the issuing of the sub-processes, the performing of the sub-processes, and the providing of the cluster intermediate results may be repeatable over a number of iterations or epochs. Consequently, the offloading that goes on at each stage enables each of the host CPU, and cluster CPU to engage in other activities while this process is going on. Furthermore, it will be appreciated that the repetition that occurs, is able to occur without repeated instruction from the previous device. For example, issuing of sub-processes can occur over a number of epochs without being directly instructed to perform particular tasks at each iteration by the host CPU 100. Again, this makes it possible for the host CPU 100 (for instance) to engage in other activities without needing to provide ongoing support or instruction to the cluster CPU 120.

FIG. 13 shows an example of capability determination. At step 902, the host CPU 100 makes a request for capabilities to the cluster CPU 120. Having received the request at step 904, eight further capabilities request is sent from the cluster CPU 122 the tile CPUs 114. Each of the tile CPUs 114 then provide a response to the cluster CPU 120 indicating their capabilities. At step 906, these capabilities are combined in order to form a capability set. At step 908, capabilities of the cluster CPU 120 may then be added into the set. In any case, the resulting capability set is then returned to the host CPU 100.

As a consequence of this, the cluster CPU 120 is able to better determine how sub-processes should be allocated to tile CPUs 114 based on the capabilities of each tile CPU 114. Furthermore, the host CPU 100 is able to determine whether a particular machine learning process can be offloaded to the cluster CPU 120. This can be useful in a situation where multiple cluster CPUs 120 exist, each with different capabilities. Of course, the specifics of each tile CPU 114 may be hidden from the host CPU 100, which generally is not concerned about the specifics of how the cluster CPU 120 is comprised. Instead, the host CPU 100 is concerned with whether a cluster CPU 120 is able to perform an offloaded machine learning process.

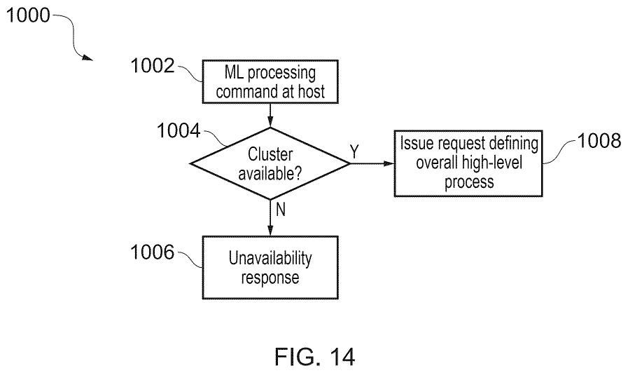

FIG. 14 illustrates, in the form of a flowchart 1000, a process that may be executed at the host CPU 100. The process may correspond with the step 804 that is illustrated in FIG. 12.

At a step 1002, a machine learning processing command is encountered at the host CPU 100. At a step 1004, it is determined whether the cluster 110 is available. In this case, the availability may not merely check that the cluster 110 is connected, powered, and/or available to receive offloaded machine processing requests, but also that the cluster 110 has the capabilities necessary to perform the offloaded machine processing request. This may be made with reference to the capability set as described in FIG. 13. Of course, in other embodiments, the capability set is ignored and the cluster availability merely refers to the existence of the cluster 110 together with its ability to receive a request. In any event, if the cluster is considered to be available, then at step 1008, a request is issued by the host CPU 100 to the cluster CPU 120. The request defines an overall high-level machine learning process that is to be performed. For example, the request may be hardware-agnostic and thus present the machine learning process in a manner that is not specific to any hardware that is being executed. In some examples, the request is provided at a sufficiently high level that even the fact that the process is a machine learning process may not be immediately obvious. In some examples, the request may not indicate how the request is to be performed, and may not indicate how the request is to be decomposed into a number of sub-processes. In the alternative, if the cluster is not considered to be available, then an unavailability response is produced.

There are a number of possibilities for the form that the unavailability response may take, in particular, this may depend on the nature of what it means for the cluster 110 to be unavailable. In some examples, this may involve raising an error at the host CPU 100. In other examples, the host CPU 100 may be made to participate in the machine learning process itself. Another action that can be taken is for a user of the host CPU 100 to be alerted to the fact that the cluster appears to be unavailable or incapable of performing the requested operation. In practice, a further option is for an interrupter exception to be thrown thereby allowing software executing at the host CPU 100 to respond. This can be a useful option, since the software will be available of the request that was being made and what the consequences are for the operation not being performed. A still further option, is for a predetermined delay to take place and for the determination process to take place again. This makes it possible to deal with the situation in which the cluster 110 was temporarily unavailable. Of course, it is possible for other unavailability response is to be taken. Similarly, it is possible for a combination of responses to occur.

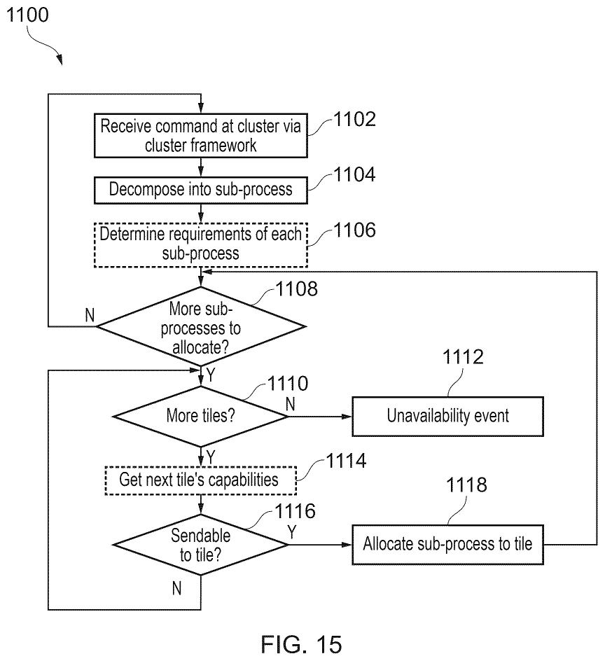

FIG. 15 illustrates, in the form of a flowchart 1100, an example of how a request for a machine learning process can be decomposed into a number of sub-processes and distributed among tile CPUs 114. It will be appreciated that a similar process can be used for the decomposition of sub-processes into asynchronous tasks that occurs at the tile CPUs 114, with the asynchronous tasks containing accelerator instructions and being performed by the accelerators and comprising one or more accelerator instructions. In this example, the decomposition and distribution takes into account the capabilities of the tiles 112. However, this need not be the case and decomposition and distribution can occur without reference to these capabilities.

At a step 1102, a command is received at a cluster CPU 120 in machine learning process to be performed. The request is received via a cluster framework, that in this example executes as a runtime on the cluster CPU 120. At step 1104, the machine learning process that is to be performed is decomposed into a number of sub-processes. For example, a neural network can be represented as a graph of operations, which can be decomposed into multiple sub-graphs of operations which can be allocated for execution. It will be appreciated that the present techniques are applicable to training as well as inference. Consequently, decomposition of the machine learning process can also take place by testing different weights and biases for a particular neural network architecture, with each sub process relating to a different combination of weights and biases. Regardless of how the decomposition is performed, an optional step 1106 can take place in which the requirements of each sub process are determined. For instance, a particular sub-process may necessitate an amount of memory or access to a restricted resource in order to be properly executed. Whether or not the optional step 1106 is performed, step 1108 defines the start of a loop that is performed. In particular, step 1108 determines whether there are more sub-processes to be allocated to tiles. If not, then all the sub-processes have been allocated, and the process returns to step 1102 to await a further command to perform a machine learning process. If there are more sub-processes to allocate, the process proceeds to step 1110 with step 1110 defining an inner loop. In particular, step 1110 determines whether there are more tiles to be considered. If not, then an unavailability event 1112 occurs and the significance of this step is explained in more detail below. Otherwise, an optional step 1114 may occur before proceeding to step 1116. At step 1114, the capabilities of the next available tile are obtained. At step 1116, it is determined whether the sub-process is appropriate to be allocated to this next tile. If so, then at step 1118, the sub-process is allocated to the tile and the process returns to step 1108. Otherwise, if the sub-process is not appropriate for assignment to the tile (for instance if the tile is unavailable or in a situation where capabilities are being determined, the tile does not have the necessary capabilities) then the process returns to step 1110 where it is determined whether other tiles can be considered. Thus, each sub-process is considered in turn, and for each sub-process the first tile that is encountered that is able to receive the sub-process is allocated that sub-process.

In a situation in which no tile exists to which a sub-process can be issued, the unavailability event occurs (step 1112). The significance of the unavailability event depends on the nature of how appropriateness is determined at step 1116. If appropriateness is determined based on tile capabilities, then the unavailability event 1112 may indicate that there is no tile available that can meet the requirements. In this case, it may be necessary to raise an error at the host CPU 100 in order to indicate that the requested process cannot be performed. Alternatively, if the appropriateness is determined based on current availability or busyness, then it may be sufficient for a predetermined period to elapse before testing each the tiles for appropriateness again. That is to say that if there is currently no tile that is free, then it may be appropriate to wait a period of time in order to see whether a tile becomes available. If this process is repeated a number of times unsuccessfully then it may be concluded that no tile will ever become available and so it may be appropriate to report an error back to the host CPU 100. In particular, such an error may indicate that the host CPUs have crushed, e.g. by entering an infinite loop.

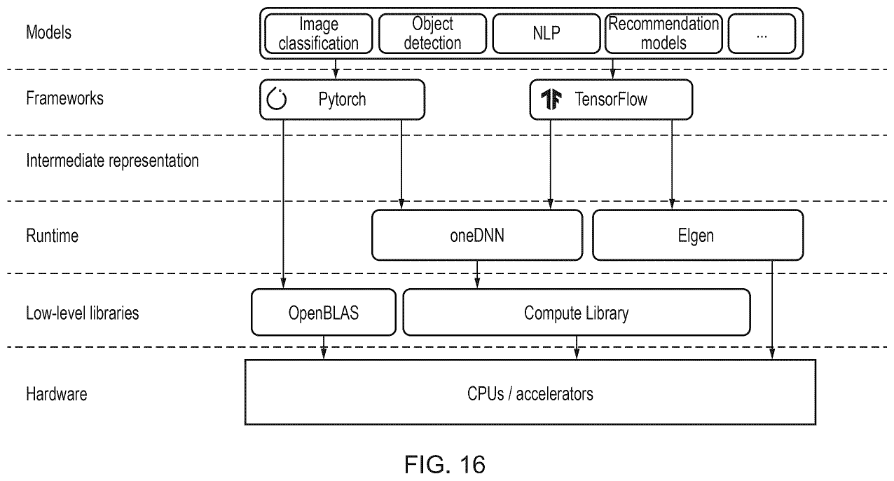

FIG. 16 illustrates an example of the software stack that may be used within the system. In this example, a number of different models are provided. For example, models may be provided for image classification, object detection, natural language processing (NLP), and recommendation models. These models may be defined in or may make use of one or more frameworks such as PyTorch or TensorFlow. The Frameworks may make use of a runtime such as oneDNN or Eigen or can make direct use of low level libraries such as OpenBLAS and Compute Library. The runtimes may also make use of particular CPUs or accelerators and similarly, the low-level libraries may provide commands that directly control or are configured specifically for such hardware.

Much like other abstraction representations, a higher level in this representation makes use of (e.g. makes function calls for) functionality provided by a lower level according to defined software interfaces. In general, the host CPU 100 provides functionality at the higher levels of this representation, the cluster CPU provides functionality at the middle levels of this representation, and the tiles provide functionality at the lower levels of this representation with the accelerators 116 providing the functionality at the lowest levels. Of course, the host CPU 100 could provide functionality at an even higher level than that illustrated in FIG. 16. For example, the host CPU 100 could enable a programmer to specify a machine learning process to be performed without reference to any particular machine learning model. Similarly, it will be appreciated that the functionality provided by one of the entities may span across multiple levels of the representation. For example, the host CPU 100 may enable a programmer to simply specify a task to be performed and may enable a programmer to specify a particular model to be used. In some cases, one part of the representation may span across multiple elements of the system. For instance, a framework may be provided at both the host CPU and the cluster CPU and the two halves of the framework may communicate with each other (e.g. via an API). In some cases, one half of the framework may even be ‘compiled away’ where the other half may be provided as a runtime to run under the operating system of another component (e.g. at the host).

It will be appreciated that since the specific hardware control occurs at the lowest levels of the representation illustrated in FIG. 16, that the request for the machine learning process that is issued by the host CPU 100 is hardware agnostic.

FIGS. 17A and 17B illustrate two different examples in which a machine learning request can be issued by the host CPU 100.

FIG. 17A shows a first example of issuing a machine learning request in which an instruction executed at the host CPU 100 takes the form of the function call ‘framework_execute (pycode*)’, which is a specific request for the framework to execute Python code 1200 located at an address in memory indicated by the pointer. In this example, it can be seen that the Python code 1200 contains a function call to the PyTorch framework. As a consequence of executing this instruction, a request is issued by the host CPU 100 to the cluster CPU 120. The request is issued in accordance with an API provided by the cluster CPU 120. In this example, the request may simply indicate a pointer to the Python code (pycode*) and provides the functionality that the given Python code will be executed. Consequently, when request is received by the cluster CPU 120 (or a framework or runtime executing on the cluster CPU 120) the specified Python code is executed. This in turn causes a call into the Pytorch framework 1202 to occur. The PyTorch framework is implemented in C++ and causes a number of small accelerator programs to be executed by the tiles 116. The selection of which accelerator programs are to be executed, when, and by which tiles is left to the PyTorch framework. In execution of the accelerator programs, data may be written to memory where it can be accessed by the cluster CPU 120 and/or the tile CPUs 114.

Thus in this example, it is possible for the host CPU 100 to offload a machine learning task (inference or training) so that the host CPU 100 is able to perform further tasks in the background without needing to provide individual instructions to the tiles 116. It will be noted that since the host CPU 100 runs a first operating system and the cluster CPU 120 runs a second operating system, that the specific architecture of the cluster 110 and particularly the number and specific capabilities of each individual tile 112 need not be known by the host CPU 100. Consequently, as can be seen from example in FIG. 17A, the request that is made at the host CPU 100 is hardware agnostic. That is to say that the same code could be executed on a different cluster 110 having different hardware capabilities.

FIG. 17B shows a second example of issuing a machine learning request in which an instruction executed at the host CPU 100 takes the form of the function call ‘issue_ml_inference (model=4, data=data*)’. This is a specific request for the framework to perform machine learning inference using a model with the identifier four and data indicated by the pointer. This request is issued to the cluster CPU 120 in accordance with an API provided by the cluster CPU 120. The specifics of how the particular model are to be used for inference are not elaborated on here but are provided by a cluster framework executing on the cluster CPU 120 (i.e. under the direction of the second operating system). The framework is therefore able to decompose and distribute individual sub-processes to the tiles 116 based on the nature of the model, for instance. For example, if model number four is used for image categorisation, then the decomposition that occurs could occur in relation to the image that would be provided as the input data (data*). Such decomposition could take the form of splitting the image into a number of macro blocks, with each sub-process being directed towards the analysis of an individual block. Other forms of decomposition are of course possible. The term ‘model’ here is being used to refer to both the architecture of (for instance) a neural network as well as the specific trained biases and weights. In other examples, such as when the machine learning process is training, the model may refer only to the architecture, with the weights and biases being determined separately.

It will be appreciated that this merely provides two different examples of how the host CPU 100 can be enabled to offload machine learning processing to the cluster 110, and the cluster 110 can decompose and distribute the task in order to perform the task efficiently.

Although not explicitly illustrated in either of FIG. 17A or 17B, the machine learning process could take the form of training. In a training process, the model is trained to correspond with the set of input data so that it provides a ‘best match’ against that input data. Having trained the model against the input data, later ‘use data’ can be provided to the model in order to produce a result or output. For instance, a model could be trained against a set of images and cats and dogs, as well as a definitive indicator of whether any given image is of a cat or a dog, in order to produce a model that theoretically will indicate whether any later given arbitrary image is of a cat or a dog. In practice, the result of applying such a model may be a numerical value between 0 and 1 where 0 indicates (e.g.) ‘cat’ and 1 indicates (e.g.) ‘dog’. The result value then indicates how much like a cat or a dog a given image is. In order to perform the training, an error function is used in order to determine how accurate a prediction is from the true value. In the previous example, this could simply be equal to the distance from the true value. So if ‘cat’ had been predicted and the result had produced a value of 0.2 then 0.2 would be the error. If ‘dog’ had been predicted and the result had produced a value of 0.4 then the error would be 0.6 (1−0.4). The goal of the training process is to produce a model (e.g. by adjusting weights) in which the error function is minimised for the set of training data. The training period defines how long the training should continue for. This represents the fact that it may never be known with certainty as to whether the model has reached a perfect state and so the indicated training period indicates when training should stop.

In the case of training, still further parameters may be provided by the host CPU 100. For instance, an initial set of weights may be provided, in some examples, the error or loss function may be specified and/or a learning step size may be provided. Furthermore, a training period may be specified. This can be specified as, for instance, a length of calendar time, a number of epochs or iterations to be executed, a number of clock cycles, or an improvement gradient to be achieved. This latter possibility measures the improvement that has been achieved over the last number of iterations and is therefore indicative of whether the training process is continuing to produce significant improvements or not. In other examples, depending on the level of abstraction provided, these parameters may be selected by the cluster CPU 120. In still other examples, the host CPU 100 may indicate a preference for particular parameters, which may be overridden by the cluster CPU 120 using its knowledge of the underlying architecture of the cluster 110.

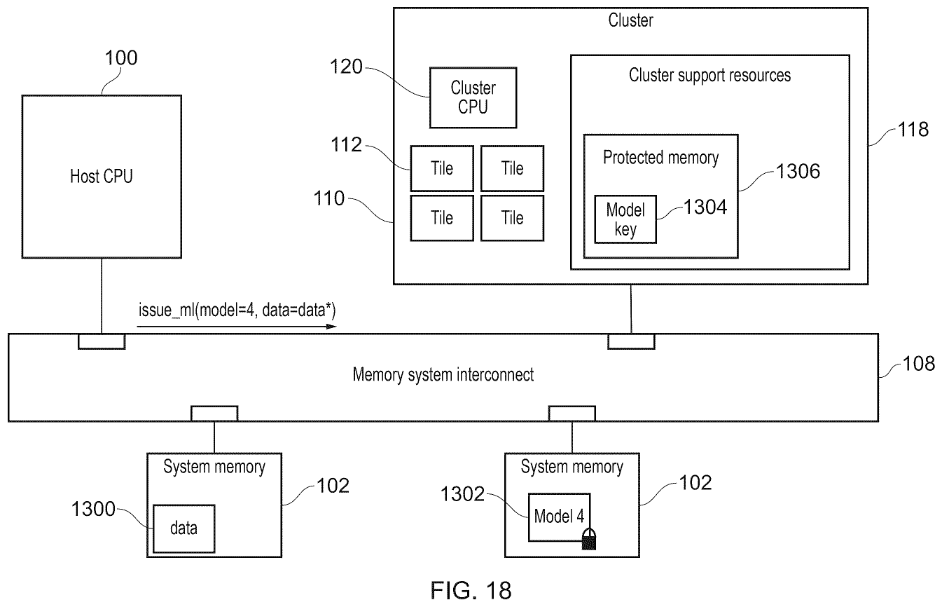

FIG. 18 illustrates the manner in which security can be used with a model. In particular, this follows the example of FIG. 17B in which a specific machine learning processes specified by the request issued from the host CPU 100 to the cluster CPU 120. Here, it can be seen that model 4 1302 is encrypted in the system memory 102. The decryption key 1304 that can be used to access the model 1302 is provided within protected memory 1306 within the cluster support resources 118 of the cluster 110. Meanwhile, the data 1300 to be used with the model is unencrypted within system memory 1302. Since the decryption key 1304 is stored within protected memory 1306 on the cluster 110, the model 1302 can be provided to an operator of the overall system without the user being able to directly access the model 1302. Thus an owner of the model can maintain control of it, while still enabling it to be used under particular control circumstances. For instance, the model key 1304 may only be usable if particular licensing restrictions are met. At the same time, privacy of the data 1300 is maintained, because an operator of the system is able to use the data and indeed the model 1302 on their own device. Consequently, use of the model 1302 can be controlled while maintaining privacy of the underlying data 1300.

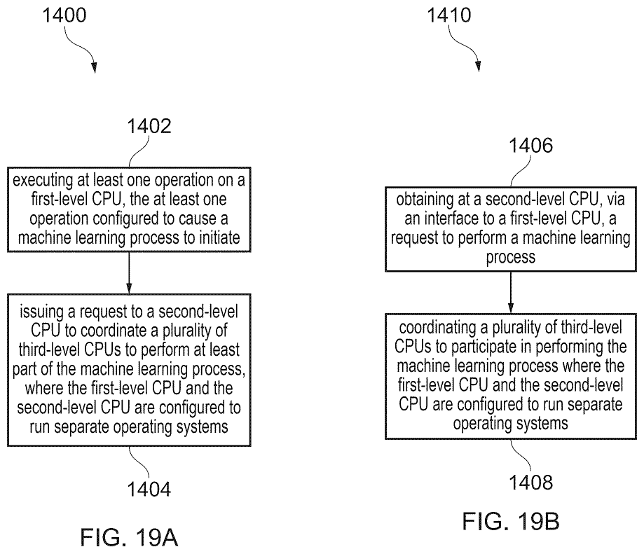

FIG. 19A illustrates a method in accordance with some examples shown in the form of a flowchart 1400. At a step 1402, at least one operation is executed on a first-level CPU (also referred to as a host CPU 100 or a system CPU). The at least one operation is configured to cause a machine learning process to initiate. At a step 1404, as a consequence of executing the at least one operation on the first level CPU, the first level CPU issues a request to a second level CPU (also referred to as a cluster CPU 120) to coordinate a plurality of third level CPUs (also referred to as tile CPUs 114) to perform at least part of the machine learning process where the first level CPU 100 and the second level CPU 120 run separate operating systems.

FIG. 19B illustrates a method in accordance with some examples shown in the form of a flowchart 1410. At a step 1406, a second level CPU obtains (via an interface to a first level CPU) a request for machine learning process. Then, at step 1408, the second level CPU coordinates a plurality of third level CPUs 114 to participate in performing the machine learning process, where the first level CPU in the second level CPU are configured to run separate operating systems.

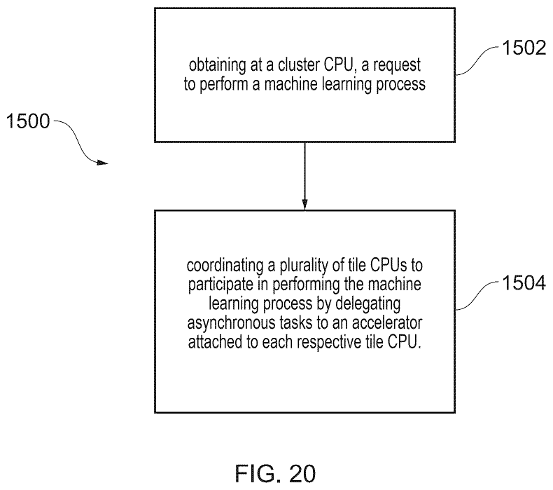

FIG. 20 illustrates a method in accordance with some examples shown in the form of a flowchart 1500. At a step 1502, a request to perform a machine learning process is obtained at a cluster CPU 120. Then, at a step 1504, the cluster CPU 120 coordinate a plurality of tile CPUs 114 to participate in the machine learning process by delegating asynchronous tasks to an accelerator 116 attached to each respective tile CPU 114.

Further examples are set out in the following clauses:

A1. An apparatus comprising:
a plurality of compute tiles coupled via a tile cluster interconnect;
each compute tile comprising:
a tile central processing unit (CPU); and
a hardware accelerator configured to perform, asynchronously with respect to operations performed by processing circuitry of the tile CPU, a delegated task offloaded to the hardware accelerator by the tile CPU.
   A2. The apparatus according to clause A1, in which the hardware accelerator comprises accelerator circuitry configured to accelerate operations for one or more machine learning workloads.
   A3. The apparatus according to any of clauses A1 and A2, in which for a given compute tile, the hardware accelerator is private to the tile CPU of that given compute tile.
   A4. The apparatus according to any of clauses A1 to A3, in which, for a given compute tile, the tile CPU is configured to exchange control signals with the hardware accelerator via an accelerator control interface separate from the tile cluster interconnect.
   A5. The apparatus according to any of clauses A1 to A4, in which, for a given compute tile, the hardware accelerator is configurable based on instructions executed by the tile CPU in an operating state with user-level privilege.
   A6. The apparatus according to any of clauses A1 to A5, in which, for a given compute tile, the tile CPU and the hardware accelerator are configured to share memory management circuitry.
   A7. The apparatus according to any of clauses A1 to A6, in which, for a given compute tile, the tile CPU and the hardware accelerator are configured to share at least one private cache.
   A8. The apparatus according to any of clauses A1 to A7, in which each compute tile comprises an associated system cache.
   A9. The apparatus according to any of clauses A1 to A8, comprising a cluster host CPU coupled to the plurality of compute tiles via the tile cluster interconnect.
   A10. The apparatus according to clause A9, in which the cluster host CPU is configured to delegate compute tasks to the respective compute tiles.

All. The apparatus according to any of clauses A9 and A10, in which the cluster host CPU is configured to communicate with a host compute system to accept offloading of a compute task from the host compute system to a compute cluster comprising the cluster host CPU and the plurality of compute tiles.

A12. The apparatus according to any of clauses A9 to A11, in which the cluster host CPU is configured to receive job requests from a host compute system and to dispatch jobs to the compute tiles.
A13. The apparatus according to any of clauses A9 to A12, in which the cluster host CPU is configured to decompose a compute task offloaded by the host compute system into sub-tasks to be performed by the plurality of compute tiles.
A14. The apparatus to any of clauses A1 to A13, comprising system interface circuitry configured to provide an interface between:
a compute cluster comprising the plurality of compute tiles and the tile cluster interconnect; and
a host compute system comprising at least one CPU and system memory.
   A15. The apparatus according to clause A14, in which the system interface circuitry comprises a peripheral interconnect.
   A16. The apparatus according to clause A14, in which the system interface circuitry comprises an inter-chiplet interconnect.
   A17. The apparatus according to clause A14, in which the system interface circuitry comprises a memory system interconnect.
   A18. The apparatus according to any of clauses A14 to A17, comprising cluster memory storage circuitry private to the compute cluster and inaccessible to the host compute system.
   A19. The apparatus according to clause A18, in which the cluster memory storage circuitry comprises high bandwidth memory (HBM).
   A20. The apparatus according to any of clauses A1 to A19, comprising, coupled to the tile cluster interconnect, at least one of:
a system control processor configured to perform system initialization;
a security engine configured to provide confidential compute functionality;
debugging circuitry;
an interrupt controller; and
a peripheral interface.
   A21. The apparatus according to any of clauses A1 to A20, in which the tile cluster interconnect comprises a coherent mesh network.
   A22. The apparatus according to any of clauses A1 to A21, in which each tile CPU is capable of execution of at least one of:
an operating system; and
a machine learning framework.
   A23. A chiplet comprising the apparatus of any of clauses A1 to A22.
   A24. A packaged chip comprising the apparatus of any of clauses A1 to A22.
   A25. A system-on-chip comprising the apparatus of any of clauses A1 to A22.
   A26. A system comprising:
the apparatus of any of clauses A1 to A20, implemented in at least one packaged chip;
   at least one system component; and
a board,
wherein the at least one packaged chip and the at least one system component are assembled on the board.
   A27. A chip-containing product comprising the system of clause A26, wherein the system is assembled on a further board with at least one other product component.
   A28. Computer-readable code for fabrication of an apparatus comprising:
a plurality of compute tiles coupled via a tile cluster interconnect;
each compute tile comprising:
a tile central processing unit (CPU); and
a hardware accelerator configured to perform, asynchronously with respect to operations performed by a processing pipeline of the tile CPU, a delegated task offloaded to the hardware accelerator by the tile CPU.
   A29. A storage medium storing the computer-readable code.
   B1. A compute system comprising:
a CPU (central processing unit) hierarchy comprising:
   a first-level CPU;
   a second-level CPU; and
   a plurality of third-level CPUs.
      B2. The compute system according to clause B1, in which each third-level CPU has a corresponding hardware accelerator.
      B3. The compute system according to clause B2, in which each third-level CPU comprises an accelerator interface configured to communicate with the corresponding hardware accelerator to control offloading of a delegated task to the corresponding hardware accelerator.
      B4. The compute system according to clause B2, in which the corresponding hardware accelerator is configured to perform the delegated task asynchronously with respect to operations performed on a processing pipeline of the third-level CPU.
      B5. The compute system according to any of clauses B2 to B4, in which the corresponding hardware accelerator for a given third-level CPU is private to the given third-level CPU.
      B6. The compute system according to any of clauses B2 to B5, in which the corresponding hardware accelerator comprises accelerator circuitry configured to accelerate operations for one or more machine learning workloads.
      B7. The compute system according to any of clauses B1 to B6, in which the first-level CPU is configured to offload compute tasks to the second-level CPU and the second-level CPU is configured to offload compute tasks to the third-level CPUs.
      B8. The compute system according to any of clauses B1 to B7, in which the second-level CPU is configured to receive job requests from the first-level CPU and to dispatch jobs to the third-level CPUs.
      B9. The compute system according to any of clauses B1 to B8, in which the second-level CPU is configured to decompose an offloaded compute task offloaded by the first-level CPU into sub-tasks to be performed by the third-level CPUs.
      B10. The compute system according to any of clauses B1 to B9, in which the first-level CPU and the second-level CPU are configured to communicate via a primary interconnect; and
the second-level CPU and the third-level CPUs are configured to communicate via a secondary interconnect separate from the primary interconnect.
   B11. The compute system according to clause B10, in which the primary interconnect comprises a plurality of primary interconnect endpoint interfaces; and
the secondary interconnect is coupled to at least one of the primary interconnect endpoint interfaces.
   B12. The compute system according to clause B11, in which the first-level CPU is coupled to at least one other of the primary interconnect endpoint interfaces.
   B13. The compute system according to any of clauses B10 to B12, in which the secondary interconnect comprises a plurality of secondary interconnect endpoint interfaces;
at least one of the secondary interconnect endpoint interfaces is coupled to the primary interconnect; and
the second-level CPU and the third-level CPUs are coupled to respective secondary interconnect endpoint interfaces of the secondary interconnect.
   B14. The compute system according to any of clauses B10 to B13, in which the secondary interconnect comprises a coherent interconnect.
   B15. The compute system according to any of clauses B10 to B14, in which the secondary interconnect comprises a mesh network.
   B16. The compute system according to any of clauses B10 to B15, in which the primary interconnect comprises a memory system interconnect.
   B17. The compute system according to clause B16, wherein the primary interconnect comprises a non-coherent interconnect.
   B18. The compute system according to any of clauses B10 to B15, in which the primary interconnect comprises a peripheral interconnect.
   B19. The compute system according to any of clauses B10 to B15, in which the primary interconnect comprises an inter-chiplet interconnect.
   B20. The compute system according to any of clauses B10 to B19, comprising system memory storage circuitry coupled to the primary interconnect and shared for access by the first-level CPU, the second-level CPU and the third-level CPUs.
   B21. The compute system according to clause B20, in which the first-level CPU is configured to access the system memory storage circuitry via the primary interconnect; and
the second-level CPU and the third-level CPUs are configured to access the system memory storage circuitry via a path comprising the secondary interconnect and the primary interconnect.
   B22. The compute system according to any of clauses B1 to B20, comprising cluster memory storage circuitry accessible to a cluster comprising the second-level CPU and the third-level CPUs.
   B23. The compute system according to clause B22, wherein the cluster memory storage circuitry is inaccessible to the first-level CPU.
   B24. The compute system according to any of clauses B22 and B23, in which the cluster memory storage comprises high-bandwidth memory.
   B25. The compute system according to any of clauses B1 to B24, in which at least the first-level CPU and the second-level CPU are capable of execution of at least one of:
an operating system; and
a machine learning framework.
   B26. The compute system according to clause B25, in which the third-level CPUs are also capable of execution of at least one of the operating system and the machine learning framework.
   B27. The compute system according to any of clauses B1 to B26, in which the second-level CPU is configured to support an N-bit architecture, where N is greater than 32.
   B28. The compute system according to any of clauses B1 to B27, in which the third-level CPUs are configured to support an N-bit architecture, where N is greater than 32.
   B29. A chiplet comprising:
an interface configured to communicate with a first-level central processing unit (CPU) of a CPU hierarchy;
a second-level CPU of the CPU hierarchy; and
a plurality of third-level CPUs of the CPU hierarchy.
   B30. A packaged chip comprising the compute system of any of clauses B1 to B28.
   B31. A system-on-chip comprising the compute system of any of clauses B1 to B28.
   B32. A system comprising:
the compute system of any of clauses B1 to B28, implemented in at least one packaged chip;
   at least one system component; and
a board,
wherein the at least one packaged chip and the at least one system component are assembled on the board.
   B33. A chip-containing product comprising the system of clause B32, wherein the system is assembled on a further board with at least one other product component.
   B34. Computer-readable code for fabrication of a compute system comprising:
a CPU (central processing unit) hierarchy comprising:
   a first-level CPU;
   a second-level CPU; and
   a plurality of third-level CPUs.
      B35. A storage medium storing the computer-readable code of clause B34.
      C1. A data processing method comprising:
executing at least one operation on a first-level CPU, the at least one operation configured to cause a machine learning process to initiate; and
   issuing a request to a second-level CPU configured to coordinate a plurality of third-level CPUs to perform at least part of the machine learning process, wherein
   the first-level CPU and the second-level CPU run separate operating systems.
      C2. The data processing method according to clause C1, comprising:
determining whether the second-level CPU is available to the first-level CPU; and
in response to a result of the determining being that the second-level CPU is available to the first-level CPU, performing the issuing.
   C3. The data processing method according to clause C2, wherein
in response to the result of the determining being that the second-level CPU is unavailable to the first-level CPU, causing an unavailability response to occur.
   C4. The data processing method according to any of clauses C1-C3, wherein
the machine learning process is defined at the first-level CPU at a same or higher level of abstraction than is used at the second-level CPU.
   C5. The data processing method according to any one of clauses C1-C4, wherein
the issuing the request to the second-level CPU occurs via an API.
   C6. The data processing method according to any one of clauses C1-C4, wherein
the request is issued to the second-level CPU via a host machine learning framework executing on an operating system of the first-level CPU.
   C7. The data processing method according to clause C6, wherein
the host machine learning framework utilises an API by which the request is issued by the first-level CPU; and
the request comprises an indication as to the process and the data to use when executing the process.
   C8. The data processing method according to any one of clauses C6-C7, wherein
the host machine learning framework is configured to communicate with a cluster machine learning framework executing on a cluster operating system of the second-level CPU.
   C9. The data processing method according to any of clauses C1-C8, wherein
the request is issued to the second-level CPU and is handled by the cluster machine learning framework executing on the cluster operating system of the second-level CPU.
   C10. The data processing method according to any of clauses C1-C9, wherein
the issuing the request to the second-level CPU occurs via an API operating on a host operating system on the first-level CPU.
   C11. The data processing method according to any of clauses C1-C9, wherein
the request comprises an indication of the machine learning process to be performed and an indication as to the data on which to operate the machine learning process.
   C12. The data processing method according to clause C5 or clause C7, wherein
the API specifies parameters of the machine learning process to be performed.
   C13. The data processing method according to any one of clauses C5, C7, or C12, wherein
the API is configured to enable the machine learning process to be issued to the second-level CPU; and
the machine learning process is decomposed, at the second-level CPU, into sub-processes for execution across the second-level CPU and the third-level CPUs.
   C14. The data processing method according to any one of clauses C5, C7, or C12-C13, wherein
the machine learning process is decomposed for a first time, at the second-level CPU, into sub-processes for execution across the second-level CPU and the third-level CPUs.
   C15. The data processing method according to any one of clauses C5, C7, or C12-C14, wherein
the API is configured to allow the machine learning process to be specified in a hardware agnostic manner.
   C16. The data processing method according to clause C9, wherein
the cluster machine learning framework is configured to obtain the request comprising an indication of one or more second-level instructions configured to be executed on the second-level CPU.
   C17. The data processing method according to clause C16, wherein
the one or more second-level instructions cause execution of one or more asynchronous tasks on the third-level CPUs.
   C18. The data processing method according to clause C17, wherein
at least some of the second-level instructions and the asynchronous tasks comprise an indication of the input data and the model.
   C19. The data processing method according to any one of clauses C16-C17, wherein
the machine learning process comprises a training process; and
at least some of the second-level instructions and the asynchronous tasks comprise one or more training parameters.
   C20. The data processing method according to clause C19, wherein
the one or more training parameters comprise an indication of an error function.
   C21. The data processing method according to any of clauses C1-C20, wherein
the machine learning process comprises an inference process.
   C22. The data processing method according to any of clauses C1-C21, wherein
the model is encrypted using a key; and
the key is held in a trusted execution environment accessible to at least one of the second-level CPU and the third-level CPUs and inaccessible to the first-level CPU.
   C23. The data processing method according to any of clauses C1-C22, comprising:
receiving an indication of a result of the machine learning process at the first-level CPU.
   C24. The data processing method according to any of clauses C1-C23, wherein
the machine learning process takes place over a plurality of epochs.
   C25. The data processing method according to any of clauses C1-C24, wherein
the machine learning process that is performed by the second level CPU and at least one of the third level CPUs comprises a decision of whether to continue the machine learning process for another iteration.
   C26. A data processing method comprising:
obtaining at a second-level CPU, via an interface to a first-level CPU, a request to perform a machine learning process; and
coordinating a plurality of third-level CPUs to participate in performing the machine learning process, wherein
the first-level CPU and the second-level CPU run separate operating systems.
   C27. An apparatus configured to perform the method of any of clauses C1-C26.
   C28. A non-transitory computer-readable medium storing computer-readable code for fabrication of an apparatus configured to perform the method of any of clauses C1 to C26.
   C29. A system comprising:
the apparatus of clause C27, implemented in at least one packaged chip;
at least one system component; and
a board, wherein
the at least one packaged chip and the at least one system component are assembled on the board.
   C30. A chip-containing product comprising the system of clause C29, wherein the system is assembled on a further board with at least one other product component.
   D1. A data processing method comprising:
obtaining at a cluster CPU, a request to perform a machine learning process; and
coordinating a plurality of tile CPUs to participate in performing the machine learning process, wherein
the tile CPUs participate in performing the machine learning process by delegating asynchronous tasks to an accelerator attached to each respective tile CPU.
   D2. The data processing method according to clause D1, wherein
the asynchronous tasks executed by the accelerator attached to each respective tile CPU are to execute operations corresponding to at least a part of a directed graph of operations.
   D3. The data processing method according to any of clauses D1 and D2, wherein
the request is provided in a hardware agnostic manner.
   D4. The data processing method according to any of clauses D1 to D3, wherein
the machine learning process is defined as a single combined process.
   D5. The data processing method according to any of clauses D1 to D4, comprising: providing an indication to a host CPU that at least one of the cluster CPU and at least one of the plurality of tile CPUs are available.
   D6. The data processing method according to any of clauses D1 to D5, comprising: determining one or more capabilities of the tile CPUs to form a set of capabilities.
   D7. The data processing method according to clause D6, comprising:
determining one or more capabilities of the cluster CPU to add to the set of capabilities.
   D8. The data processing method according to any one of clauses D6-D7, comprising:
decomposing the machine learning process based on the set of capabilities into a set of sub-processes to be allocated for execution across the cluster CPU and the tile CPUs.
   D9. The data processing method according to any one of clauses D1-D7, comprising: decomposing the machine learning process into a set of sub-processes to be allocated for execution across the cluster CPU and the tile CPUs.
   D10. The data processing method according to any one of clauses D8-D9, wherein
the sub-processes comprise at least one pre-processing sub-process executed on the cluster CPU to prepare workloads for allocation.
   D11. The data processing method according to any one of clauses D8-D10, comprising:
distributing at least a portion of the set of sub-processes among the tile CPUs; and
further decomposing, at the tile CPU, the at least a portion of the set of sub-processes to generate a plurality of asynchronous tasks to be executed at the accelerators.
   D12. The data processing method according to any one of clauses D8-D11, wherein
the further decomposing also causes the at least a portion of the set of sub-processes to generate a pre-processing task that is executed on the tile CPU.
   D13. The data processing method according to any of clauses D1 to D12, comprising:
obtaining an indication of a result, an intermediate result, or a partial result of the machine learning process:
from the accelerator at the respective tile CPU and/or
from each of the tile CPUs at the cluster CPU.
   D14. The data processing method according to any of clauses D1 to D13, comprising:
obtaining a tile intermediate result from the accelerator at the respective tile CPU; and
using the tile intermediate result from each of the tile CPUs to generate a cluster intermediate result.
   D15. The data processing method according to clause D14, wherein
the cluster intermediate result is generated using the tile intermediate result from the accelerator over a plurality of epochs.
   D16. The data processing method according to any of clauses D1 to D15, comprising: obtaining a cluster intermediate result from each of the tile CPUs at the cluster CPU; and using the cluster intermediate result from each of the tile CPUs to generate a result.
   D17. The data processing method according to clause D16, wherein
the result is generated using the cluster intermediate result from each of the tile CPUs over a plurality of epochs.
   D18. The data processing method according to any one of clauses D16-D17, comprising:
providing an indication of a final result to a host CPU.
   D19. The data processing method according to any of clauses D1 to D18, wherein
the cluster CPU is configured to obtain the request to perform the machine learning process from a host CPU.
   D20. The data processing method according to any of clauses D1 to D19, wherein
the host CPU and the cluster CPU run separate operating systems.
   D21. The data processing method according to any of clauses D1 to D20, wherein
the request is issued to the cluster CPU and is handled by a cluster machine learning framework executing on a cluster operating system of the cluster CPU.
   D22. The data processing method according to any of clauses D1 to D21, wherein
the issuing the request to the cluster CPU occurs via an API operating on a host operating system on the host CPU.
   D23. The data processing method according to any one of clauses D1-D22, wherein
the request comprises an indication of the machine learning process to be performed and an indication as to the data on which to operate the machine learning process.
   D24. The data processing method according to clause D23, wherein
the machine learning process comprises a training process; and the definition comprises an indication of one or more training parameters.
   D25. The data processing method according to clause D24, wherein
the one or more training parameters comprise an indication of an error function.
   D26. The data processing method according to any of clauses D1 to D25, wherein
the request comprises an indication of one or more cluster instructions configured to be executed on the cluster CPU.
   D27. The data processing method according to clause D26, wherein
the one or more cluster instructions cause execution of one or more asynchronous tasks on the tile CPUs.
   D28. The data processing method according to any of clauses D1 to D27, wherein
the model is encrypted using a key; and
the key is held in a trusted execution environment accessible to at least one of the cluster CPU and the tile CPUs and inaccessible to the host CPU.
   D29. An apparatus configured to perform the method of any of clauses D1 to D28.
   D30. A non-transitory computer-readable medium storing computer-readable code for fabrication of an apparatus configured to perform the method of any of clauses D1 to D28.
   D31. A system comprising:
the apparatus of clause D29, implemented in at least one packaged chip;
at least one system component; and a board, wherein
the at least one packaged chip and the at least one system component are assembled on the board.
   D32. A chip-containing product comprising the system of clause D31, wherein the system is assembled on a further board with at least one other product component.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A data processing method comprising:
executing at least one operation on a first-level CPU, the at least one operation configured to cause a machine learning process to initiate; and
issuing a request to a second-level CPU configured to coordinate a plurality of third-level CPUs to perform at least part of the machine learning process, wherein
the first-level CPU and the second-level CPU run separate operating systems.

2. The data processing method according to claim 1, comprising:
determining whether the second-level CPU is available to the first-level CPU; and
in response to a result of the determining being that the second-level CPU is available to the first-level CPU, performing the issuing.

3. The data processing method according to claim 2, wherein
in response to the result of the determining being that the second-level CPU is unavailable to the first-level CPU, causing an unavailability response to occur.

4. The data processing method according to claim 1, wherein
the machine learning process is defined at the first-level CPU at a same or higher level of abstraction than is used at the second-level CPU.

5. The data processing method according to claim 1, wherein
the issuing the request to the second-level CPU occurs via an API.

6. The data processing method according to claim 1, wherein
the request is issued to the second-level CPU via a host machine learning framework executing on an operating system of the first-level CPU.

7. The data processing method according to claim 6, wherein
the host machine learning framework utilises an API by which the request is issued by the first-level CPU; and
the request comprises an indication as to the process and the data to use when executing the process.

8. The data processing method according to claim 6, wherein
the host machine learning framework is configured to communicate with a cluster machine learning framework executing on a cluster operating system of the second-level CPU.

9. The data processing method according to claim 1, wherein
the request is issued to the second-level CPU and is handled by the cluster machine learning framework executing on the cluster operating system of the second-level CPU.

10. The data processing method according to claim 1, wherein
the issuing the request to the second-level CPU occurs via an API operating on a host operating system on the first-level CPU.

11. The data processing method according to claim 1, wherein
the request comprises an indication of the machine learning process to be performed and an indication as to the data on which to operate the machine learning process.

12. The data processing method according to claim 5, wherein
the API specifies parameters of the machine learning process to be performed.

13. The data processing method according to claim 5, wherein
the API is configured to enable the machine learning process to be issued to the second-level CPU; and
the machine learning process is decomposed, at the second-level CPU, into sub-processes for execution across the second-level CPU and the third-level CPUs.

14. The data processing method according to claim 5, wherein
the machine learning process is decomposed for a first time, at the second-level CPU, into sub-processes for execution across the second-level CPU and the third-level CPUs.

15. The data processing method according to claim 5, wherein
the API is configured to allow the machine learning process to be specified in a hardware agnostic manner.

16. The data processing method according to claim 9, wherein
the cluster machine learning framework is configured to obtain the request comprising an indication of one or more second-level instructions configured to be executed on the second-level CPU.

17. The data processing method according to claim 16, wherein
the one or more second-level instructions cause execution of one or more asynchronous tasks on the third-level CPUs.

18. The data processing method according to claim 17, wherein
at least some of the second-level instructions and the asynchronous tasks comprise an indication of the input data and the model.

19. The data processing method according to claim 16, wherein
the machine learning process comprises a training process; and
at least some of the second-level instructions and the asynchronous tasks comprise one or more training parameters.

20. The data processing method according to claim 19, wherein
the one or more training parameters comprise an indication of an error function.

21. The data processing method according to claim 1, wherein
the machine learning process comprises an inference process.

22. The data processing method according to claim 1, wherein
the model is encrypted using a key; and
the key is held in a trusted execution environment accessible to at least one of the second-level CPU and the third-level CPUs and inaccessible to the first-level CPU.

23. The data processing method according to claim 1, comprising:
receiving an indication of a result of the machine learning process at the first-level CPU.

24. The data processing method according to claim 1, wherein
the machine learning process takes place over a plurality of epochs.

25. The data processing method according to claim 1, wherein
the machine learning process that is performed by the second level CPU and at least one of the third level CPUs comprises a decision of whether to continue the machine learning process for another iteration.

26. A data processing method comprising:
obtaining at a second-level CPU, via an interface to a first-level CPU, a request to perform a machine learning process; and
coordinating a plurality of third-level CPUs to participate in performing the machine learning process, wherein
the first-level CPU and the second-level CPU run separate operating systems.

27. An apparatus configured to perform the method of claim 1.

28. A non-transitory computer-readable medium storing computer-readable code for fabrication of an apparatus configured to perform the method of claim 1.

29. A system comprising:
the apparatus of claim 27, implemented in at least one packaged chip;
at least one system component; and
a board, wherein
the at least one packaged chip and the at least one system component are assembled on the board.

30. A chip-containing product comprising the system of claim 29, wherein the system is assembled on a further board with at least one other product component.
